(19) United States
(12) Patent Application Publication
(10) Pub. No.: US 2025/0015867 A1
(43) Pub. Date: Jan. 9, 2025

(54) NETWORK NODE-TO-RIS BEAM REFINEMENT

(71) Applicant: QUALCOMM Incorporated, San Diego, CA (US)

(72) Inventors: Narayan PRASAD, Westfield, NJ (US); Navid ABEDINI, Basking Ridge, NJ (US); Tao LUO, San Diego, CA (US); Junyi LI, Fairless Hills, PA (US)

(21) Appl. No.: 18/349,061

(22) Filed: Jul. 7, 2023

(51) Int. Cl. H04B 7/06; H04B 7/08

(52) U.S. Cl. CPC H04B 7/06958; H04B 7/0802; H04B 7/0697

(57) ABSTRACT

A method of wireless communication at a first network node is disclosed herein. The method includes performing beam training with a RIS-MT array, wherein the RIS-MT array is associated with a RIS array. The method includes identifying, based on the beam training, a first beam for communication with the RIS-MT array. The method includes transmitting communication to the RIS array for reflection or refraction to a wireless device using a second beam based, at least in part, on the first beam identified for the RIS-MT array.

### TECHNICAL FIELD

The present disclosure relates generally to communication systems, and more particularly, to wireless communication including reconfigurable intelligent surface (RIS) beam refinement.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a first network node are provided. The apparatus includes at least one memory and at least one processor coupled to the memory and, based at least in part on information stored in the at least one memory, the at least one processor, individually or in any combination, is configured to cause the first network node to: perform beam training with a reconfigurable intelligent surface (RIS) mobile terminal (RIS-MT) array, where the RIS-MT array is associated with a RIS array, identify, based on the beam training, a first beam for communication with the RIS-MT array; and transmit communication to the RIS array for reflection or refraction to a wireless device using a second beam based, at least in part, on the first beam identified for the RIS-MT array.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A illustrates a blockage to wireless communication between a base station and a UE.

FIG. 4B illustrates a RIS that intelligently reflects communication between a base station and a UE.

FIG. 5 illustrates a RIS that intelligently reflects communication between a base station and a UE.

FIG. 6 is a diagram illustrating example aspects pertaining to a RIS.

FIG. 7 is a diagram illustrating an example of base station to RIS beam refinement via translation.

FIG. 8 is a diagram illustrating an example of base station to RIS beam refinement using a buddy node.

FIG. 9 is a diagram illustrating an example of base station to RIS beam refinement using a buddy node and simultaneous reception of multiple beams.

FIG. 10 is a diagram illustrating an example of base station to RIS beam refinement using retro-reflection.

FIG. 11 is a diagram illustrating an example of base station to RIS beam refinement using retro-reflection and reflected signal frequency translation.

FIG. 12 is a diagram illustrating example aspects of frequency translation via a time-varying control.

FIG. 13 is a diagram illustrating example aspects of an initialization scheme for base station to RIS beam refinement.

FIG. 14A is a communication flow diagram illustrating example communications between a first network node, a second network node, a network entity, a RIS array, a RIS-MT array, and a wireless device.

FIG. 14B is a communication flow diagram illustrating example communications between a first network node, a second network node, a network entity, a RIS array, a RIS-MT array, and a wireless device.

FIG. 14C is a communication flow diagram illustrating example communications between a first network node, a second network node, a network entity, a RIS array, a RIS-MT array, and a wireless device.

FIG. 15 is a diagram illustrating example aspects of base station to RIS beam refinement.

FIG. 16 is a flowchart of a method of wireless communication.

FIG. 17A is a flowchart of a method of wireless communication.

FIG. 17B is a flowchart of a method of wireless communication.

FIG. 17C is a flowchart of a method of wireless communication.

FIG. 18 is a diagram illustrating an example of a hardware implementation for an example apparatus and/or network entity.

FIG. 19 is a diagram illustrating an example of a hardware implementation for an example network entity.

FIG. 20 is a diagram illustrating an example of a hardware implementation for an example network entity.

FIG. 21 is a diagram illustrating an example of a hardware implementation for a RIS.

### DETAILED DESCRIPTION

A RIS may be utilized to increase coverage/spectral efficiency in a wireless communication system. For instance, a line-of-sight (LoS) may not exist between a base station (e.g., a gNB or another network node) and a wireless device (e.g., a UE) due to a blockage. The base station may transmit signals via a beam for reflection or refraction to the wireless device via the RIS. The RIS may include a RIS array and a reconfigurable intelligent surface mobile terminal (RIS-MT) array. The RIS array and the RIS-MT array may have different capabilities, for instance, the RIS-MT may be capable of engaging in beam training procedures, while the RIS array may not be capable of engaging in beam training procedures. The base station may engage in a beam training procedure with the RIS-MT array to determine a transmit beam or a receive beam for reflection or refraction to the wireless device; however, the transmit beam or the receive beam may not be an optimal beam, as the RIS-MT array and the RIS array may have different characteristics (e.g., different sizes, different orientations, different numbers of antenna elements, etc.). Thus, when the base station transmits a signal for reflection or refraction to the wireless device via the RIS array using a beam determined based on beam training with a RIS-MT, communication reliability may be impacted. Furthermore, the RIS array may operate with a reduced number of antenna elements in certain situations, which may also cause the transmit beam or the receive beam to not be an optimal beam. Additionally, a partial blockage may occur between the base station and the RIS array, which may cause the transmit beam or the receive beam to not be an optimal beam.

Various aspects pertaining to base station to RIS beam refinement are described herein. Some aspects more specifically relate to base station to RIS beam refinement using a second network node that may be referred to herein as a “buddy node.” In an example, a first network node performs beam training with a reconfigurable intelligent surface (RIS) mobile terminal (RIS-MT) array, where the RIS-MT array is associated with a RIS array. The first network node identifies, based on the beam training, a first beam for communication with the RIS-MT array. The first network node transmits communication to the RIS array for reflection or refraction to a wireless device using a second beam based, at least in part, on the first beam identified for the RIS-MT array.

Particular aspects of the subject matter described in this disclosure can be implemented to realize one or more of the following potential advantages. Vis-à-vis the above-described technologies, the second beam used for the communication may be a more optimal beam in comparison to the first beam. Thus, the above-described technologies may increase coverage/spectral efficiency in a wireless communication system. Furthermore, the above-described technologies may be advantageous in identifying a beam for transmitting communication for reflection or refraction to a wireless device in scenarios in which a RIS array is operating with disabled sub-arrays or antenna elements and in scenarios in which there is a partial obstruction of a Los between a base station and the RIS array.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

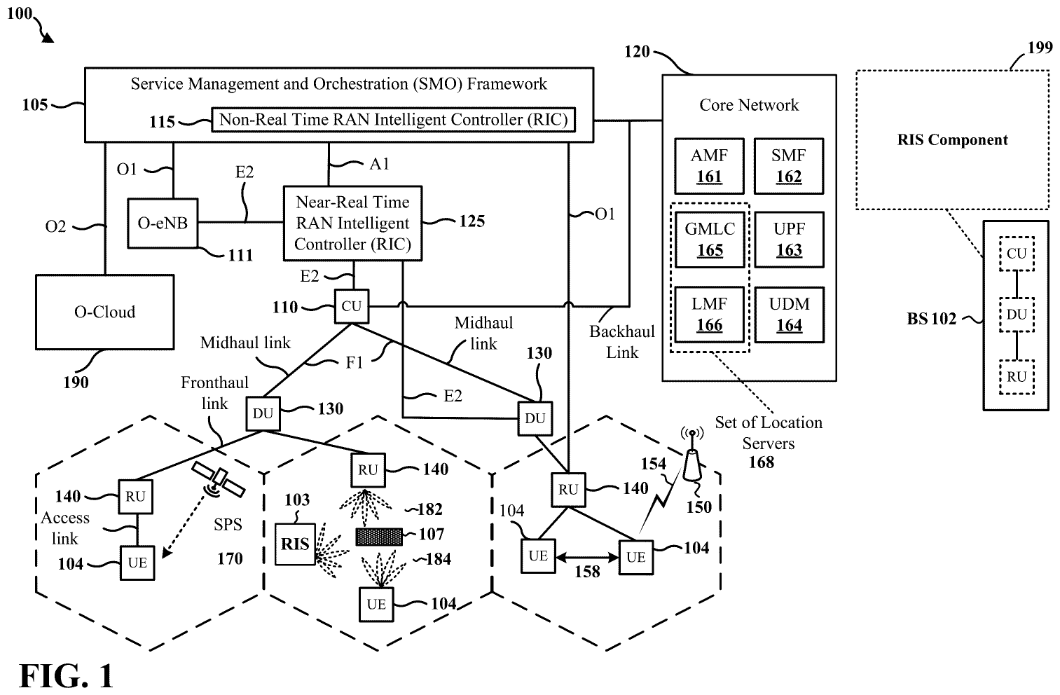

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHz), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network

(WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

In some aspects, the wireless communication system may include one or more reflective intelligent surfaces (RIS) 103, which may also be referred to by other names. A blockage 107 may occur between a network node transmitting to a UE 104 and the UE 104. The RIS 103 may include a passive antenna array with a surface with a large number of placed reconfigurable elements that can reflect or refract an electromagnetic wave in target directions. In an example, the large number of placed reconfigurable elements may be a large number of densely placed reconfigurable elements. In another example, the large number of placed reconfigurable elements may be a large number of non-densely placed reconfigurable elements. The RIS 103 may receive communication, e.g., from the RU 140 or the UE 104, at an incident angle and may reflect or transmit the communication at an angle of reflection, e.g., by controlling reflection coefficients of the antenna elements of the RIS surface, to avoid the blockage 107. The RIS 103 receives and reflects or transmits the communication without decoding the communication.

In certain aspects, the base station 102 may have a RIS component 199 that may be configured to perform beam training with a reconfigurable intelligent surface (RIS) mobile terminal (RIS-MT) array, where the RIS-MT array is associated with a RIS array; identify, based on the beam training, a first beam for communication with the RIS-MT array; and transmit communication to the RIS array for reflection or refraction to a wireless device using a second beam based, at least in part, on the first beam identified for the RIS-MT array. Although the following description may be focused on 5G NR, the concepts presented herein may also be applicable to other wireless communication systems (e.g., 6G).

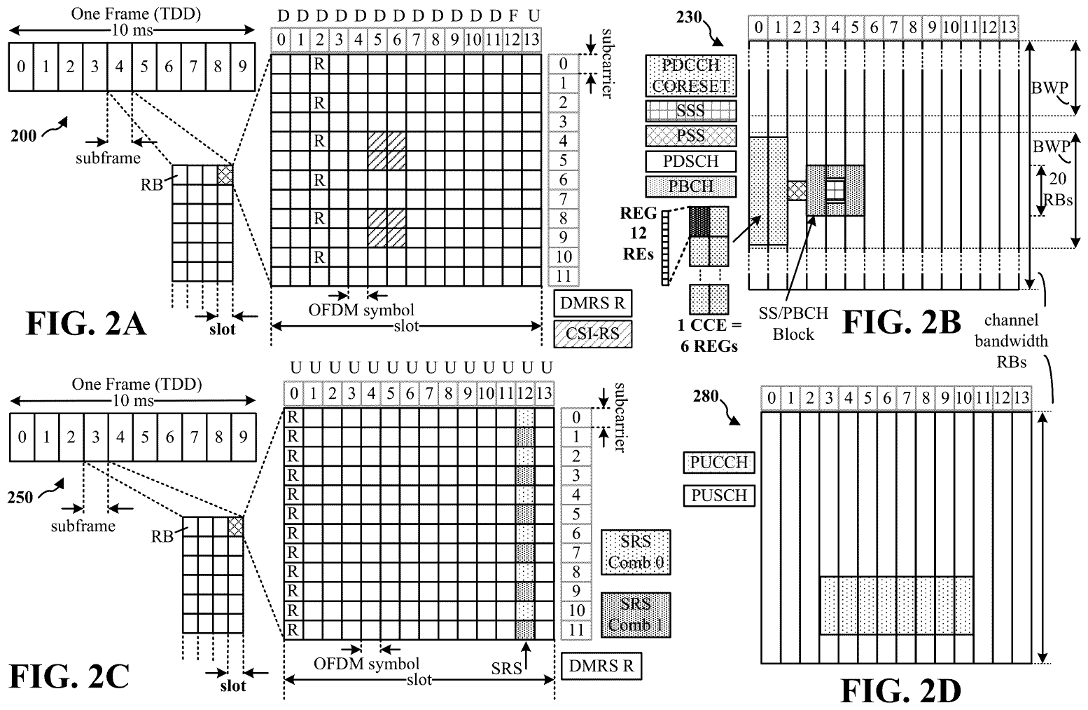

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

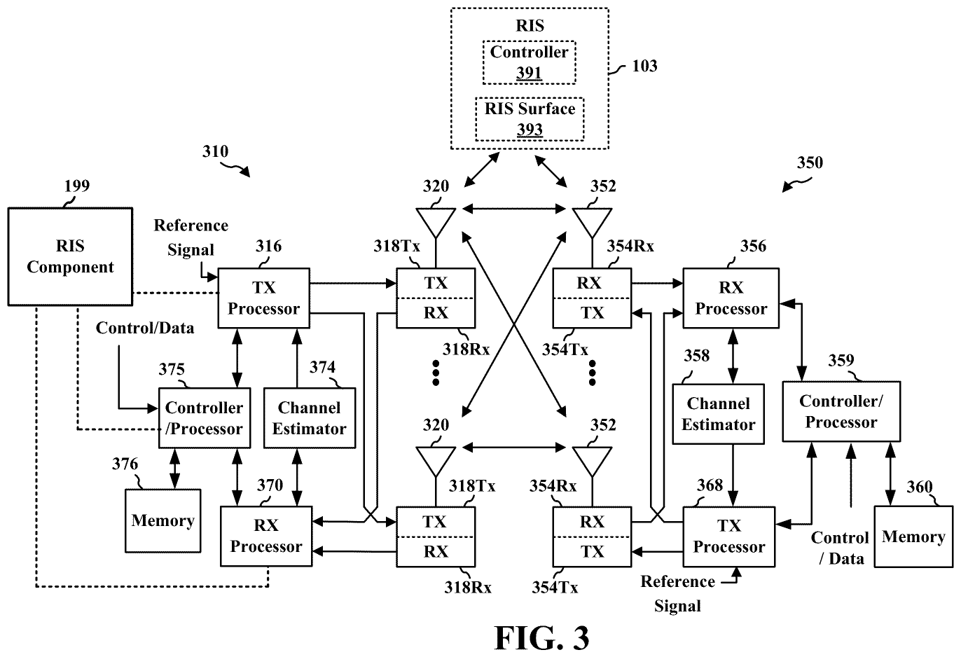

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

FIG. 3 illustrates an example of a RIS 103 that is configured to reflect communication between the base station 310 and the UE 350. The RIS 103 includes a RIS surface 393 of elements that are reconfigurable for different incident angles and reflection angles. The RIS 103 may also include a controller 391 that controls the reflection coefficients of the RIS surface 393 to adjust the angles. In some aspects, the controller 391 may include communication components, e.g., including Tx processor, and Rx processor, and/or a controller processor, such as described for the base station 310 and/or UE 350, in order to receive control signaling regarding the control of the RIS surface 393.

At least one of the TX processor 316, the RX processor 370, and the controller/processor 375 may be configured to perform aspects in connection with the RIS component 199 of FIG. 1.

Beamforming gain may be achieved through the use of active antenna units. Individual RF chains may be used per antenna port. The use of active antenna units

(AAU) may increase power consumption. A reconfiguration intelligent surface (RIS) may be employed to extend coverage, e.g., beamformed coverage, with reduced power consumption. The RIS may include a larger number of uniformly distributed electrically controllable elements. Each RIS element may have a reconfigurable electromagnetic characteristic, e.g., a reflection or a refraction coefficient. Depending on the combination of configured states of the elements, the RIS may reflect or refract and modify the incident radio waveform in a controlled manner, such as changing a reflected or a refracted direction, changing a beam width, etc. The RIS may function as a near passive device, and the reflection or the refraction direction may be controlled by the base station. The RIS may reflect or refract an impinging wave in a direction indicated by the base station to a UE.

A RIS may be deployed in wireless communication systems, including cellular systems, such as LTE, NR, etc. A RIS may alter the channel realization in a controlled manner, which may improve channel diversity. The increased diversity may provide robustness to channel blocking/fading, which may be of particular importance for mmWave communication. Compared to a wireless relay or repeater systems, a RIS may be more cost and energy efficient.

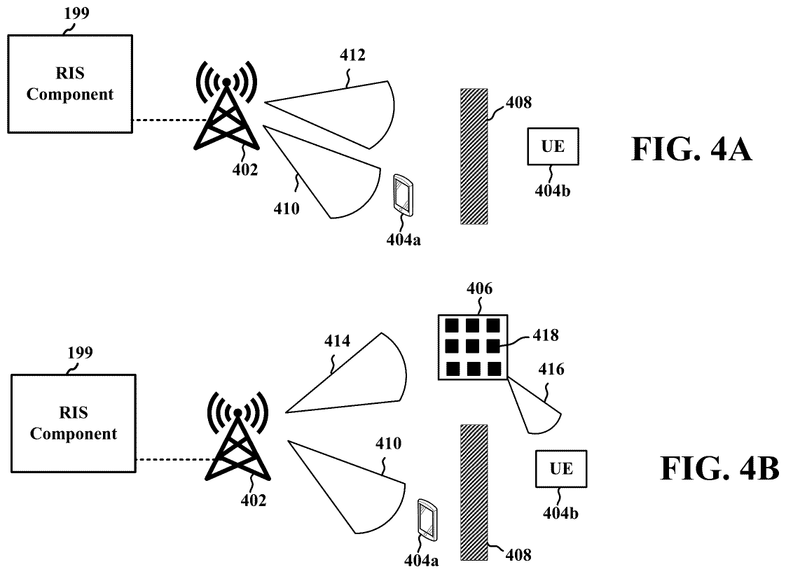

A base station may control the RIS to extend beam coverage and/or to address blockages between the base station and the UE. FIG. 4A illustrates an example in which a base station 402 transmits beamformed communication to UEs using directional beams 410, 412. A first UE 404a may be able to receive the direct transmission using the beam 410. However, FIG. 4A illustrates a blockage 408 that blocks the beam 412 from reception at the second UE 404b. As illustrated in FIG. 4B, the base station 402 may transmit communication for the second UE 404b using a directional beam 414 (which may be referred to as the impinging beam) to the RIS 406 for reflection over a directional beam 416 to the second UE 404b. The base station 402 may indicate a direction of the directional beam 416 to the RIS, and the RIS may reflect the impinging wave on beam 414 in the direction of the directional beam 416. The RIS may include multiple RIS elements 418 that are configured to adjust the reflected direction, the beam width, etc. The base station 402 may include a RIS component 199 as described in connection with FIG. 1.

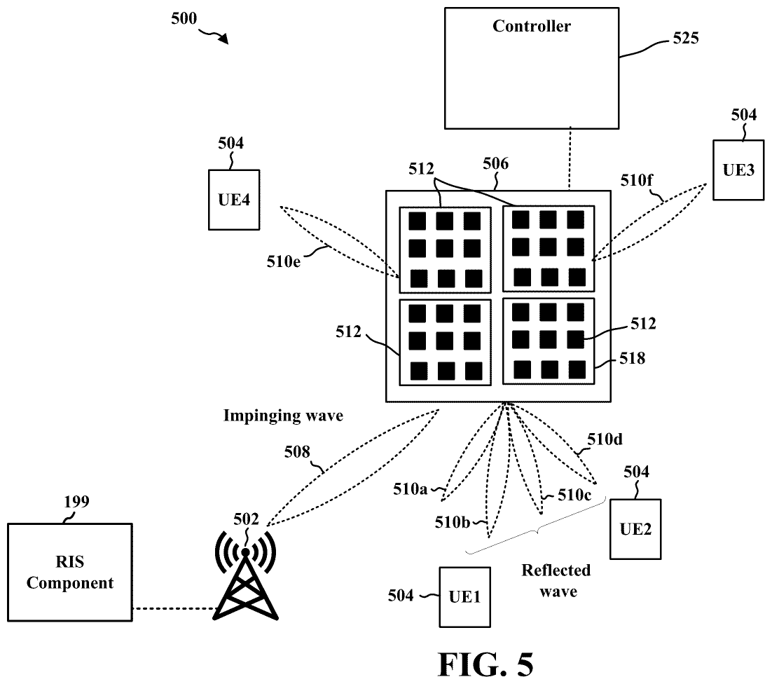

FIG. 5 is a diagram 500 illustrating an example in which the RIS 506 includes multiple subsets 512 of multiple RIS elements 518. As illustrated, the multiple subsets 512 of multiple RIS elements 518 may serve different UEs 504. The multiple RIS elements 518 may be controlled by a controller 525 at the RIS 506 based on control information received by the base station 502. As described in connection with FIG. 4B, the base station 502 may indicate a beam direction (e.g., any of 510a, 510b, 510c, 510d, 510c, or 510f) to the RIS for reflecting beamformed communication received as the impinging wave 508 to a particular UE 104 in a particular direction. The RIS may similarly be controlled by a UE for reflecting communication from the UE to a base station and/or to another UE. The base station 402 may include a RIS component 199 as described in connection with FIG. 1.

The RIS may be controlled by a base station 502 and/or a UE 504, which may be referred to as the control node for the RIS. The UE and/or the base station use the RIS for communication, sensing, and/or positioning functions. RIS information may be known by a network based on network planning, and the base station may provide the RIS position and other RIS information to other nodes (e.g., UEs in the cell). For example, the base station may transmit the RIS information in system information. The UEs in the coverage of the cell may receive the system information in order to discover the presence of a RIS, the RIS position, the RIS capabilities, or other RIS information about a particular RIS. In some aspects, a RIS may be autonomously deployed by an operator or by a third party user. e.g., and may not be a part of a planned network. In some aspects, the RIS may be mobile RIS.

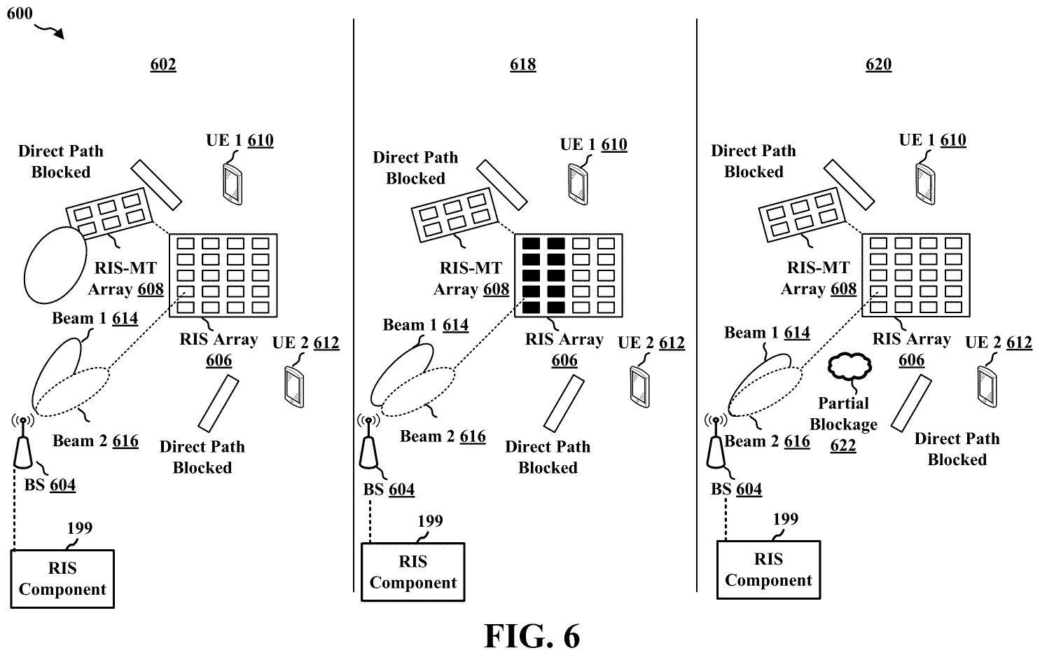

FIG. 6 is a diagram 600 illustrating example aspects pertaining to a RIS. A RIS may refer to an array (e.g., a low-cost array) of passive and reconfigurable reflecting elements that may help to boost coverage/spectral efficiency in a wireless communication system (e.g., 5G NR. 6G, etc.). A base station (e.g., a gNB) may control a RIS (e.g., provide control signaling to a RIS) to serve users (e.g., UEs) which the base station cannot serve directly. For instance, the base station may transmit communication to a UE via a RIS when a line-of-sight (LoS) does not exist between the base station and the UE. Although aspects are described for a base station, aspects may be performed by a network node that comprises a base station in aggregation or one or more components of a disaggregated base station. The base station may utilize a selected beam to transmit a signal to the RIS, where the RIS may reflect or refract the signal to a UE. With more particularity, the RIS may reflect or refract the signal at a different angle than an incident angle of the signal. A RIS may be incapable of, or may not support, amplification; however, the IRS may be able to redirect incident energy. As such, the base station may utilize an optimized beam to transmit the signal to the RIS to account for the RIS being incapable of amplification of the signal. A RIS may include a RIS array and a reconfigurable intelligent surface mobile terminal (RIS-MT) array. A base station may leverage a presence of an in-band RIS-MT to determine, or select, a beam using beam training with the RIS-MT. However, this beam may not be optimized for transmitting to (or receiving from) the RIS array, because the RIS array and the RIS-MT array may be different arrays. In an example, the RIS-MT array may have a different (e.g., a smaller) size and/or a different orientation than a size and an orientation of a RIS array. Retraining (i.e., reoptimizing) a base station to RIS beam may occur due to a RIS having to operate with deactivated sub-arrays (or elements) for power saving, due to one or more tunable components of the RIS failing, and/or due to a partial obstruction arising along a base station to RIS LoS path.

The base station 604 may include a RIS component 199 as described in connection with FIG. 1. Aspects described herein pertain to beam training and improved selection of a base station to RIS transmit beam and/or a base station to RIS receive beam. In some aspects, a base station may determine an initial beam via beam training with a RIS-MT array. The RIS-MT array may be in-band (i.e., the RIS-MT array and a RIS array may be capable of communication over the same frequency band) and co-located with a RIS array, the RIS-MT array may be in-band and not co-located with the RIS array, the RIS-MT array may not be in-band and the RIS-MT may be co-located with the RIS array, or the RIS-MT array may not be in-band and may not be co-located with the RIS array. The determined beam may be further refined in a refinement stage that uses a buddy node (i.e., a second base station, a second gNB, a second TRP, etc.) which either (1) measures and reports reflected or refracted signal strength or (2) transmits reference symbols that are measured by the base station. In one aspect, the buddy node may be the base station (e.g., the gNB) itself and as a result, measured signal strengths may not be reported to the base station. In another aspect, time-varying RIS control signals for frequency translation may be utilized to mitigate self-interference at the base station.

FIG. 6 at 602 depicts a base station 604 (e.g., a gNB), a RIS array 606, a RIS-MT array 608, a first UE 610, and a second UE 612. The RIS array 606 and the RIS-MT array 608 may be collectively referred to as a RIS. The RIS-MT array 608 may also be referred to as a RIS controller. In one aspect, the RIS-MT array 608 may control the RIS array 606. Blockages (illustrated as rectangles in FIG. 6) may exist which may block a direct path (i.e., a direct LoS) from the base station 604 to the first UE 610 and the second UE 612. The RIS array 606 and the RIS-MT array 608 may be different arrays. For instance, as depicted in FIG. 6, the RIS array 606 may include a first number of antenna elements (e.g., 20) and may be oriented in a first direction (e.g., straight with respect to the ground), while the RIS-MT array 608 may include a second number of antenna elements (e.g., 6) and may be oriented in a second direction (e.g., diagonal with respect to the ground), where the first number of antenna elements and the second number of antenna elements may be different, and where the first orientation and the second orientation may be different. Furthermore, as depicted in FIG. 6, the RIS array 606 may have a first size and the RIS-MT array 608 may have a second size, where the first size and the second size may be different. In an example, the RIS array 606 may be larger than the RIS-MT array 608.

In an example, the base station 604 and the RIS-MT array 608 may communicate with one another for beam refinement purposes. For instance, via a beam training procedure with the RIS-MT array 608, the base station 604 may select a first beam 614. The base station 604 may transmit (or receive) signals via the first beam 614, where the signals may be refracted or reflected to (or from) the first UE 610 and/or the second UE 612 via the RIS array 606. However, the first beam 614 may not be an optimal beam (i.e., a beam having a highest measurement, such as a highest reference signal received power (RSRP) measurement amongst a set of measurements for a set of beams) for communication with the first UE 610 and/or the second UE 612. Instead, a second beam 616 may be an optimal beam for communication with the first UE 610 and/or the second UE 612.

In another example, at 618, the RIS array 606 may operate with de-activated sub-arrays or deactivated antenna elements (indicated in FIG. 6 by darkened rectangles) for power saving purposes or the RIS array 606 may operate with the de-activated sub-arrays or deactivated antenna elements due to one or more tunable components of the RIS array 606 failing. As a result of the de-activated sub-arrays or deactivated antenna elements, the first beam 614 may not be an optimal beam. Instead, the second beam 616 may be an optimal beam for communication with the first UE 610 and/or the second UE 612.

In a further example, at 620, a partial blockage 622 may occur between the base station 604 and the RIS array 606. As a result of the partial blockage 622, the first beam 614 may not be an optimal beam. Instead, the second beam 616 may be an optimal beam for communication with the first UE 610 and/or the second UE 612. As noted above, a RIS may be utilized to increase coverage/spectral efficiency in a wireless communication system. For instance, a LoS may not exist between a base station and a wireless device (e.g., a UE) due to a blockage. The base station may transmit signals via a beam for reflection or refraction to the wireless device via the RIS. The RIS may include a RIS array and a RIS-MT array, where the RIS array and the RIS-MT array may have different capabilities. The base station may engage in a beam training procedure with the RIS-MT array to determine a transmit beam or a receive beam; however, the transmit beam or the receive beam may not be an optimal beam, as the RIS-MT array and the RIS array may have different characteristics (e.g., different sizes, different orientations, different numbers of antenna elements, etc.). Thus, when the base station transmits a beam including a signal for reflection or refraction to the wireless device via the RIS array, communication reliability may be impacted. Furthermore, the RIS array may operate with a reduced number of antenna elements in certain situations, which may also cause the transmit beam or the receive beam to not be an optimal beam. Additionally, a partial blockage may occur between the base station and the RIS array, which may cause the transmit beam or the receive beam to not be an optimal beam.

Various technologies pertaining to base station to RIS beam refinement are described herein. In an example, a first network node performs beam training with a reconfigurable intelligent surface (RIS) mobile terminal (RIS-MT) array, where the RIS-MT array is associated with a RIS array. The first network node identifies, based on the beam training, a first beam for communication with the RIS-MT array. The first network node transmits communication to the RIS array for reflection or refraction to a wireless device using a second beam based, at least in part, on the first beam identified for the RIS-MT array. Vis-à-vis the above-described technologies, the second beam used for the communication may be a more optimal beam in comparison to the first beam. Thus, the above-described technologies may increase coverage/spectral efficiency in a wireless communication system.

Aspects presented herein may relate to techniques for network node (e.g., base station or one or more components of a base station) to RIS beam management, and specifically, training narrow beams for a network node to RIS link using a companion (buddy) TRP to help with measurements and refinement or using the network node itself. While a network node may identify an optimized beam towards a RIS-MT array, in the scenario that the RIS-MT array and a RIS array do not share the same panel (which may be the case when a RIS-MT antenna panel attempts to receive a signal from the gNB, instead of reflecting it), the optimized beam to the RIS-MT array may not be an optimized beam for the RIS array. Multiple procedures are described herein. In one procedure, a RIS may be configured to try different kinds of reflections in a codebook, and a buddy node may measure and report strengths of the different kinds of reflections. Eventually, an optimized beam may be identified by picking a beam having a highest measurement under all codebook combinations and all beam combinations. Different variations described herein may relate to different entities (e.g., different network nodes) transmitting reference symbols and different entities measuring the reference symbols.

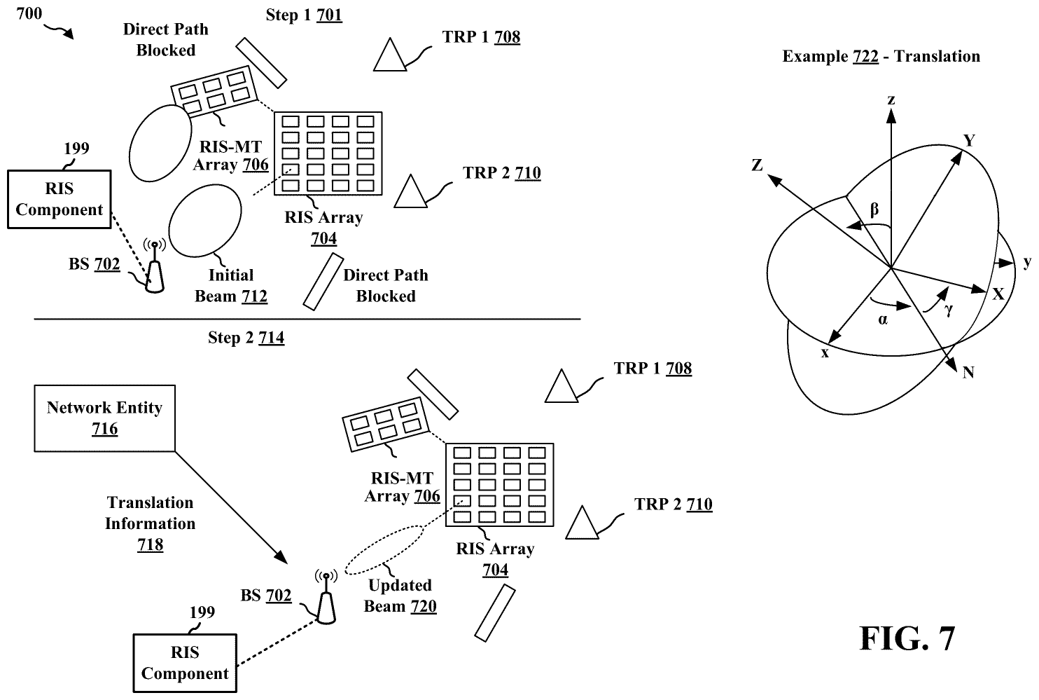

FIG. 7 is a diagram 700 illustrating an example of network node to RIS beam refinement via translation. FIG. 7 depicts a base station 702 (e.g., a gNB or other base station), a RIS array 704, a RIS-MT array 706, a first TRP 708, and a second TRP 710. Although aspects are described for a base station, aspects may be performed by a network node that comprises a base station in aggregation or one or more components of a disaggregated base station. In an example, a direct path may be blocked between the base station 702 and the first TRP 708. In another example, a direct path may be blocked between the base station 702 and the second TRP 710.

In a first step 701, the base station 702 may initiate and perform beam training with the RIS-MT array 706. The RIS-MT array 706 may be in-band and/or co-located with the RIS array 704. The beam training may result in the base station 702 selecting an initial beam 712 that may be used for communications (e.g., transmissions and/or receptions) with the RIS-MT array 706.

In a second step 714, a network entity 716 (e.g., a core network) may provide translation information 718 to the base station 702. In an example, the translation information 718 may be reference point translation information or orientation translation information. The base station 702 may utilize the translation information 718 to obtain an updated beam 720 to transmit signals for reflection or refraction to a TRP (e.g., the first TRP 708, the second TRP 710) via the RIS array 704. For instance, the base station 702 may utilize the translation information 718 to “shift” the initial beam 712 in order to obtain the updated beam 720. The updated beam 720 may be more optimal for communications that are reflected or refracted via the RIS array 704 in comparison to the initial beam 712. Via beam correspondence, the updated beam 720 may yield a beam for receiving reflections or refractions from the RIS array 704. As will be discussed in greater detail below, the updated beam 720 may be used as input for further refinement.

In an example 722 pertaining to the translation information 718, the translation information 718 may include Euler angles and a distance between reference elements for the RIS-MT array 706 and the RIS array 704 (e.g., array centroids). Euler angles (α, β, γ) may be defined for translation between two coordinate systems, that is, an XYZ coordinate system of the RIS-MT array 706 and an xyz coordinate system of the RIS array 704. In the example 722, the direction N may be defined as a cross product between z and Z, where Z and z may be aligned with normal direction to the RIS-MT array and the RIS array, respectively.

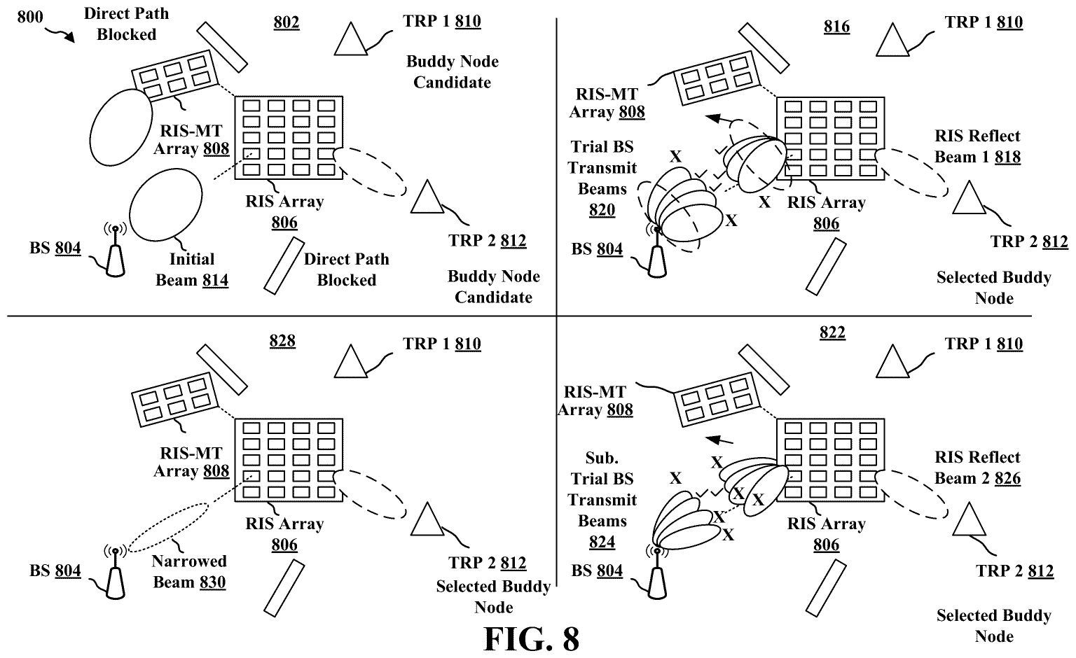

FIG. 8 is a diagram 800 illustrating an example of base station to RIS beam refinement using a buddy node. Although aspects are described for a base station, aspects may be performed by a network node that comprises a base station in aggregation or one or more components of a disaggregated base station. Similarly, the buddy node may refer to a second base station, one or more components of a base station, etc. In some aspects, the base station 804 may correspond to one TRP of a base station and the buddy node may correspond to a second TRP of the base station. At 802, FIG. 8 depicts a base station 804 (e.g., a gNB), a RIS array 806, a RIS-MT array 808, a first TRP 810, and a second TRP 812. The RIS array 806 and the RIS-MT array 808 may be collectively referred to as a RIS. In an example, a direct path may be blocked from the base station 804 to the first TRP 810 and/or a direct path may be blocked from the base station 804 to the second TRP 812. As will be described in greater detail below, the first TRP 810 and the second TRP 812 may be referred to as “buddy node candidates.” In an example, the first TRP 810 and the second TRP 812 may be base stations (e.g., gNBs or other base stations). As will be described in greater detail below, a network entity (e.g., the network entity 716, the base station 804, etc.) may identify/select a buddy node (e.g., another TRP, such as the first TRP 810 or the second TRP 812). In an example, the base station 804 may identify/select the second TRP 812 as the buddy node. The network entity may configure the buddy node to measure a signal strength over certain time frequency resources and report measured values to the base station 804. The network entity may also reveal (i.e., provide, transmit, etc.) RIS codebook(s) to the base station 804.

At 802, in a first step, the base station 804 may initiate and perform beam training with the RIS-MT array 808. The RIS-MT array 808 may be in-band with the RIS array 806. The base station 804 may determine/select/identify an initial beam 814 (i.e., a transmit beam) for communication with the RIS-MT array 808. The base station 804 may also use the initial beam 814 to transmit to the RIS array 806. In one aspect, the base station 804 may translate the initial beam 814 in a manner similar or identical to that described above in connection with FIG. 7. The base station 804 may identify candidate beams (e.g., K1 beams, where K1 is a positive integer) for the base station 804 based on the initial beam 814, where the candidate beams may be used as input for further refinement. The base station 804 may also identify RIS codebook(s) and K2 (where K2 is a positive integer) configuration(s) (i.e., patterns) in the RIS codebook(s) for the RIS, where the RIS codebook(s) and the K2 configuration(s) may also be used as input for further refinement.

In a second step, the base station 804 may convey (i.e., transmit), to the RIS-MT array 808, RIS codebook identifier(s) and K2 indices identifying configuration(s) in the RIS codebook(s). The base station 804 may also convey (i.e., transmit), to the RIS-MT array 706, a time-hopping schedule. The time-hopping schedule may include an order of applying K2 configurations on the RIS and a time duration for which each configuration is to be maintained by the RIS.

The base station 804 may transmit reference symbols using a beam over multiple-time frequency resources, where the reference symbols may be reflected or refracted (e.g., via a first RIS reflect beam 818) to the buddy node (e.g., the second TRP 812) via the RIS array 806. The buddy node may measure a reflected or a refracted signal strength over the multiple time-frequency resources. For example, the base station 804 may sequentially sweep over K1 beams in time while the RIS (i.e., the RIS array 806) maintains a configuration (i.e., a K2 configuration). The RIS may then change a configuration and the base station 804 may again sweep and transmit using K1 beams. The base station 804 may repeat this process until the RIS completes a sweep over K2 configurations. For instance, at 816, the RIS array 806 may sweep through configurations (i.e., K2 configurations) sequentially one-by-one in time. The base station 804 may sweep through beams (e.g., through trial base station transmit (Tx) beams 820) either (1) sequentially one-by-one or (2) sequentially across time groups, where the base station 804 may simultaneously transmit along multiple beams during the time groups. In FIG. 8, the check marks near the beams may indicate that a beam has a corresponding signal strength above (or at) a certain threshold and “X” marks near the beams may indicate that a beam has a corresponding signal strength below the certain threshold.

In a third step, the buddy node may transmit measurement reports for the base station 804 (e.g., via reflection or refraction by the RIS array 806), where the measurement reports include the measured reflected or refracted signal strengths over the multiple time-frequency resources. Based on the measurement reports received from the buddy node, the base station 804 may (1) select new values of K1 and K2, decide (i.e., determine) K1 base station beams and K2 RIS configurations (potentially from another RIS codebook) along with a time-hopping schedule, and continue from the second step described above with further iterations or (2) select an optimal base station beam out of the candidate beams based on certain criteria being met (e.g., a signal strength of a beam being above a threshold value). In one aspect, at the start of each iteration, the base station 804 may modify (and communicate) time-frequency resources over which the buddy node measures signal strength. Measurements of the signal strength performed by the buddy node may involve correlating measurements with known reference symbols. In an example with respect to (1), at 822, the base station 804 may transmit subsequent trial base station Tx beams 824, where the subsequent trial base station Tx beams 824 may be different (e.g., narrower, different spatial orientations, etc.) than the trial base station Tx beams 820. In an example, a second RIS reflect beam 826 may be reflected to the buddy node via the RIS array 806, where the second RIS reflect beam 826 is based on one of the subsequent trial base station Tx beams 824. In an example with respect to (2), at 828, the base station 804 may select a narrowed beam 830 for communication with a wireless device based on the narrowed beam 830 having a signal strength above a threshold value, where the narrowed beam 830 may include signals that are reflected or refracted to the wireless device via the RIS array 806. In an example, the narrowed beam 830 may be one of the trial base station Tx beams 820 or one of the subsequent trial base station Tx beams 824.

In one aspect with respect to the second step of FIG. 8 described above, base station to RIS beam refinement using the buddy node may be performed via a simultaneous transmission of multiple base station beams. For instance, the base station 804 may transmit frequency division multiplexed (FDM) reference symbols using multiple beams over multiple time-frequency resources. The buddy node may measure reflected or refracted signal strengths over the multiple time-frequency resources. In an example, the base station 804 may sequentially sweep over K1/G beam groups in time, where each beam group is associated with simultaneous transmission using G beams (K1 and G are positive integers) with FDM reference symbols while the RIS maintains a configuration. The RIS may then change a configuration and the base station 804 may again sweep and transmit using K1/G beam groups. This process may repeat until the RIS completes a sweep over K2 configurations. The buddy node may measure the FDM reference symbols by correlating the FDM reference symbols with known FDM reference symbols. Each measurement report transmitted by the buddy node may include a time-frequency identifier which may enable the base station 804 to unambiguously associate each measurement report to a transmit beam (e.g., one of the trial base station Tx beams 820, one of the subsequent trial base station Tx beams 824, etc.).

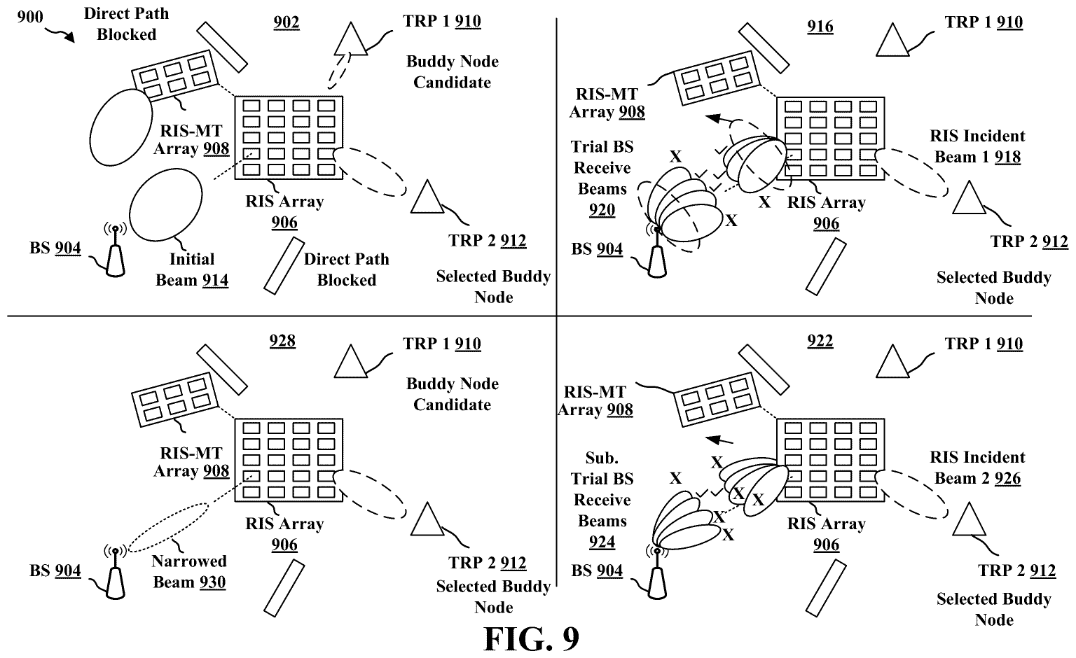

FIG. 9 is a diagram 900 illustrating an example of base station to RIS beam refinement using a buddy node and simultaneous reception of multiple beams. Although aspects are described for a base station, aspects may be performed by a network node that comprises a base station in aggregation or one or more components of a disaggregated base station. Similarly, the buddy node may refer to a second base station, one or more components of a base station. In some aspects, the base station 804 may correspond to one TRP of a base station and the buddy node may correspond to a second TRP of the base station. At 902, FIG. 9 depicts a base station 904, a RIS array 906, a RIS-MT array 908, a first TRP 910, and a second TRP 912. The RIS array 906 and the RIS-MT array 908 may be collectively referred to as a RIS. In an example, a direct path may be blocked from the base station 904 to the first TRP 910 and/or a direct path may be blocked from the base station 904 to the second TRP 912. As will be described in greater detail below, the first TRP 910 and the second TRP 912 may be referred to as “buddy node candidates.” In an example, the first TRP 910 and the second TRP 912 may be base stations. As will be described in greater detail below, a network entity (e.g., the network entity 716, the base station 904, etc.) may identify/select a buddy node (e.g., another TRP, such as the first TRP 910 or the second TRP 912). In an example, the base station 904 may identify/select the second TRP 912 as the buddy node. The network entity (e.g., the base station 904) may configure the buddy node to transmit reference symbols over certain time-frequency resources with a Tx beam that has a certain power level. The network entity may also reveal (i.e., provide, transmit, etc.) RIS codebook(s) to the base station 904. At 902, in a first step, the base station 904 may initiate and perform beam training with the RIS-MT array 908. The RIS-MT array 908 may be in-band with the RIS array 906. The base station 904 may determine/select/identify an initial beam 914 (i.e., a receive beam) for communication with the RIS-MT array 908. The base station 904 may also use the initial beam 914 to receive signals refracted or reflected by the RIS array 906. The base station 904 may identify candidate receive beams (e.g., K1 beams) for the base station 904 based on the initial beam 914, where the candidate receive beams may be used as input for further refinement. The base station 904 may also identify RIS codebook(s) and K2 configuration(s) (i.e., patterns) in the RIS codebook(s) for the RIS, where the RIS codebook(s) and the K2 configuration(s) may also be used as input for further refinement.

In a second step, the base station 904 may convey (i.e., transmit), to the RIS-MT array 908, RIS codebook identifier(s) and K2 indices identifying configuration(s) in the RIS codebook(s). The base station 904 may also convey (i.e., transmit), to the RIS-MT array 706, a time-hopping schedule. The time-hopping schedule may include an order of applying K2 configurations on the RIS and a time duration for which each configuration is to be maintained by the RIS.

The buddy node may transmit reference symbols (e.g., via a first RIS incident beam 918) over multiple time-frequency resources, where the reference symbols may be reflected or refracted by the RIS array 906. The base station 904 may receive the (reflected or refracted) reference symbols simultaneously using multiple receive beams. In an example, the base station 904 may sequentially sweep over K1/G beam groups in time, where each beam group is associated with simultaneous reception using G beams (G is a positive integer) while the RIS maintains a configuration. The RIS may then change a configuration and the base station 904 may again sweep and transmit using K1/G beam groups. This process may repeat until the RIS completes a sweep over K2 configurations. For instance, at 916, the RIS array 906 may sweep through configurations (i.e., K2 configurations) sequentially one-by-one in time. The base station 904 may sweep through beams (e.g., through trial base station receive (Rx) beams 920) either (1) sequentially one-by-one or (2) sequentially across time groups, where the base station 904 may simultaneously receive signals along multiple beams during the time groups. In FIG. 9, the check marks near the beams may indicate that a beam has a corresponding signal strength above (or at) a certain threshold and “X” marks near the beams may indicate that a beam has a corresponding signal strength below the certain threshold.

In a third step, the base station 904 may measure a reflected or a refracted signal strength over the multiple time-frequency resources. Based on the measured reflected or refracted signal strengths, the base station 904 may (1) select new values of K1, K2, and G and decide (i.e., determine) K1/G beam groups and K2 RIS configurations (potentially from another RIS codebook) along with a time-hopping schedule, and continue from the second step described above with further iterations or (2) select an optimal base station beam out of the candidate beams based on certain criteria being met (e.g., a signal strength of a beam being above a threshold value). In an example with respect to (1), at 922, the buddy node may transmit signals via beams (e.g., a second RIS incident beam 926), where the beams may be reflected or refracted by the RIS array 906. The base station 904 may sweep through beams (e.g., through subsequent trial base station receive (Rx) beams 924) either (1) sequentially one-by-one or (2) sequentially across time groups, where the base station 904 may simultaneously receive signals along multiple beams during the time groups. In an example, the subsequent trial base station Rx beams 924 may have different characteristics than the trial base station Rx beams 920. For instance, the subsequent trial base station Rx beams 924 may be narrower than the trial base station Rx beams 920. In an example with respect to (2), at 928, the base station 904 may select a narrowed beam 930 for communication with a wireless device based on the narrowed beam 930 having a signal strength above a threshold value, where the narrowed beam 930 may include signals that are reflected or refracted to the wireless device via the RIS array 906. In an example, the narrowed beam 930 may be one of the trial base station Rx beams 920 or one of the subsequent trial base station Rx beams 924. The (receive) narrowed beam 930 may also yield (e.g., enable the base station to determine) a transmit beam for the base station 904 due to beam correspondence.

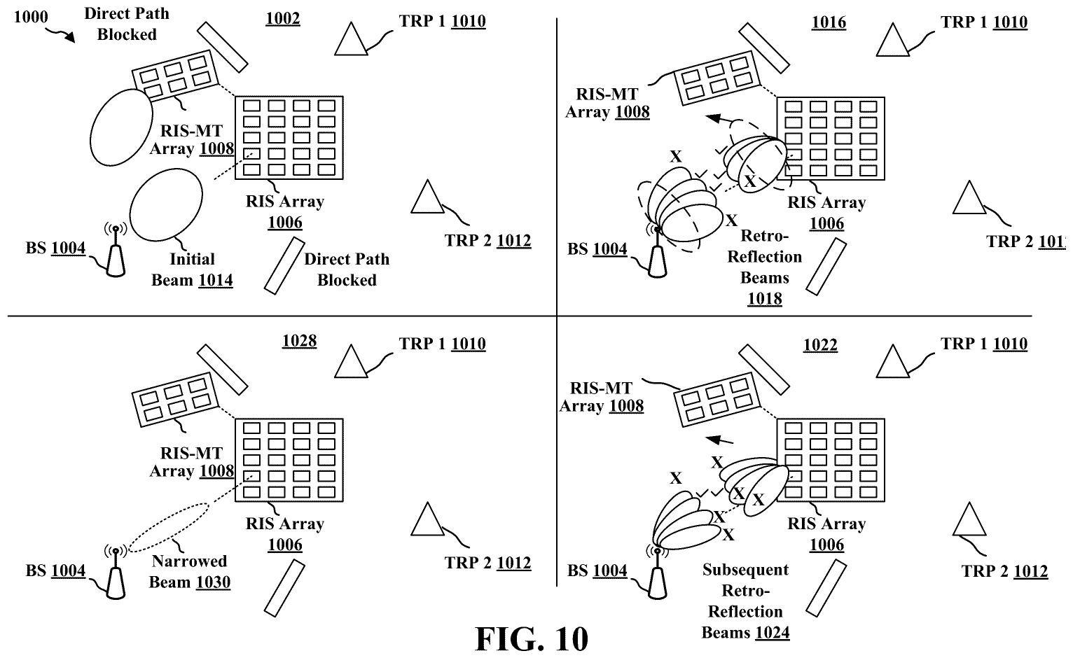

FIG. 10 is a diagram 1000 illustrating an example of base station to RIS beam refinement using retro-reflection. Although aspects are described for a base station, aspects may be performed by a network node that comprises a base station in aggregation or one or more components of a disaggregated base station. At 1002, FIG. 10 depicts a base station 1004 (e.g., a gNB), a RIS array 1006, a RIS-MT array 1008, a first TRP 1010, and a second TRP 1012. The RIS array 1006 and the RIS-MT array 1008 may be collectively referred to as a RIS. In an example, a direct path may be blocked from the base station 1004 to the first TRP 1010 and/or a direct path may be blocked from the base station 1004 to the second TRP 1012. In FIG. 10, the base station 1004 may select itself to be its own buddy node. A network entity (e.g., the network entity 716, the base station 1004, etc.) may reveal (i.e., provide, transmit, etc.) RIS codebook(s) to the base station 1004.

At 1002, in a first step, the base station 1004 may initiate and perform beam training with the RIS-MT array 1008. The RIS-MT array 1008 may be in-band with the RIS array 1006. The base station 804 may determine/select/identify an initial beam 1014 (i.e., a transmit beam) for communication with the RIS-MT array 1008. The base station 1004 may also use the initial beam 1014 to transmit to the RIS array 1006. Via beam correspondence, the initial beam 1014 may also yield a beam for receiving signals from the RIS-MT array 1008, as well as reflections or refractions of signals from the RIS array 1006. The base station 1004 may identify candidate beams (e.g., K1 beams) for the base station 1004 based on the initial beam 1014, where the candidate beams may be used as input for further refinements. The base station 1004 may also identify RIS codebook(s) and K2 retro-reflection configuration(s) (i.e., patterns) in the RIS codebook(s) for the RIS, where the RIS codebook(s) and the K2 retro-reflection configuration(s) may also be used as input for further refinement.

In a second step, the base station 1004 may convey (i.e., transmit), to the RIS-MT array 1008, RIS codebook identifier(s) and K2 indices identifying configuration(s) in the RIS codebook(s). The base station 1004 may also convey (i.e., transmit), to the RIS-MT array 1008, a time-hopping schedule. The time-hopping schedule may include an order of applying K2 retro-reflection configurations on the RIS and a time duration for which each K2 retro-reflection configuration is to be maintained by the RIS.

The base station 1004 may transmit reference symbols using a beam over multiple-time frequency resources, where the reference symbols may be reflected by the RIS array 1006 back to the base station 1004. The base station 1004 may measure a reflected signal strength over the multiple time-frequency resources via a full-duplex operation. Full-duplex may refer to the base station 1004 having the capability to simultaneously transmit and receive signals on the same frequency at the same time. For example, the base station 1004 may sequentially sweep over K1 beams in time while the RIS (i.e., the RIS array 1006) maintains a configuration. The RIS may then change a K2 retro-reflection configuration and the base station 1004 may again sweep and transmit using K1 beams. The base station 1004 may repeat this process until the RIS completes a sweep over K2 retro-reflection configurations. For instance, at 1016, the base station 1004 may transmit retro-reflection beams 1018 using a K2 retro-reflection configuration, where the retro-reflection beams 1018 may be retro-reflected by the RIS array 1006 back to the base station 1004. The base station 1004 may measure signal strengths of the retro-reflection beams 1018. In FIG. 10, the check marks near the beams may indicate that a beam has a corresponding signal strength above (or at) a certain threshold and “X” marks near the beams may indicate that a beam has a corresponding signal strength below the certain threshold.

In a third step, the base station 1004 may (1) select new values of K1 and K2, decide (i.e., determine) K1 base station beams and K2 RIS configurations (potentially from another RIS codebook) along with a time-hopping schedule, and continue from the second step described above with further iterations or (2) select an optimal base station beam out of the retro-reflection beams 1018 based on certain criteria being met (e.g., a signal strength of a beam being above a threshold value). In an example with respect to (1), at 1022, the base station 1004 may transmit subsequent retro-reflection beams 1024, where the subsequent retro-reflection beams 1024 may be different (e.g., narrower, different spatial orientations, etc.) than the retro-reflection beams 1018. In an example with respect to (2), at 1028, the base station 1004 may select a narrowed beam 1030 for communication with a wireless device based on the narrowed beam 1030 having a signal strength above a threshold value. In an example, the narrowed beam 1030 may be one of the subsequent retro-reflection beams 1024 (or one of the retro-reflection beams 1018).

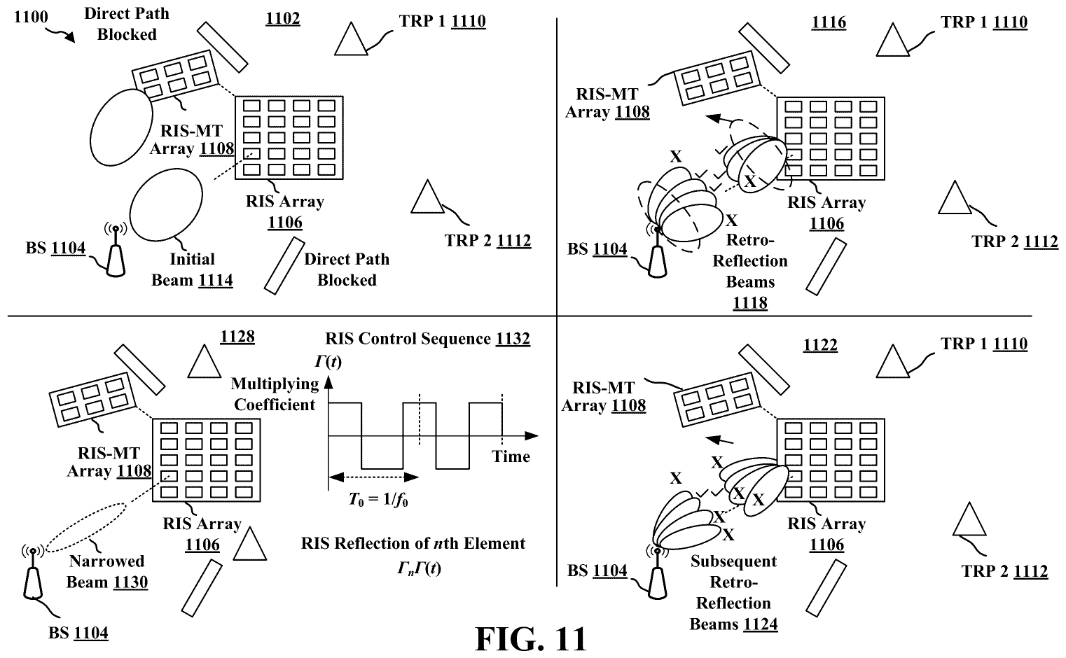

FIG. 11 is a diagram 1100 illustrating an example of base station to RIS beam refinement using retro-reflection and reflected signal frequency translation. In some cases, the base station to RIS beam refinement described above in connection with FIG. 10 may be associated with self-interference at a base station. To address self-interference, in some aspects, frequency translation by a RIS may be utilized. At 1102, FIG. 11 depicts a base station 1104, a RIS array 1106, a RIS-MT array 808, a first TRP 1110, and a second TRP 1112. Although aspects are described for a base station, aspects may be performed by a network node that comprises a base station in aggregation or one or more components of a disaggregated base station. The RIS array 1106 and the RIS-MT array 1108 may be collectively referred to as a RIS. In an example, a direct path may be blocked from the base station 1104 to the first TRP 1110 and/or a direct path may be blocked from the base station 1104 to the second TRP 1112. In FIG. 11, the base station 1104 may select itself to be its own buddy node. A network entity (e.g., the network entity 716, the base station 1104, etc.) may reveal (i.e., provide, transmit, etc.) RIS codebook(s) to the base station 1104.

At 1102, in a first step, the base station 1104 may initiate and perform beam training with the RIS-MT array 1108. The RIS-MT array 1108 may be in-band with the RIS array 1106. The base station 804 may determine/select/identify an initial beam 1114 (i.e., a transmit beam) for communication with the RIS-MT array 1108. The base station 1104 may also use the initial beam 1114 to transmit to the RIS array 1106. Via beam correspondence, the initial beam 1114 may also yield a beam for receiving signals from the RIS-MT array 1108, as well as reflections or refractions of signals from the RIS array 1106. The base station 1104 may identify candidate beams (e.g., K1 beams) for the base station 1104 based on the initial beam 1114, where the candidate beams may be used as input for further refinements. The base station 1104 may also identify RIS codebook(s) and K2 retro-reflection configuration(s) (i.e., patterns) in the RIS codebook(s) for the RIS, where the RIS codebook(s) and the K2 retro-reflection configuration(s) may also be used as input for further refinement.

In a second step, the base station 1104 may convey (i.e., transmit), to the RIS-MT array 1108, RIS codebook identifier(s) and K2 indices identifying retro-reflection configuration(s) in the RIS codebook(s). The base station 1104 may also convey (i.e., transmit), to the RIS-MT array 1108, a time-hopping schedule. The time-hopping schedule may include an order of applying K2 retro-reflection configurations on the RIS and a time duration for which each configuration is to be maintained by the RIS. The base station 1104 may also convey (i.e., transmit) an indication of a periodicity and an offset for time-varying control to the RIS-MT array 1108. The indication of the periodicity and the offset may be associated with a RIS control sequence 1132. A RIS reflection of an nth element may be provided by ΓₙΓ(t). The RIS may apply time-varying (periodic) coefficients to achieve a frequency translation in a signal reflected by the RIS array 1106.

The base station 1104 may transmit reference symbols using a beam over multiple-time frequency resources, where the reference symbols may be reflected by the RIS array 1106 back to the base station 1104 based on the periodicity and the offset for time-varying control. The base station 1104 may measure a reflected signal strength and harmonics (i.e., translated frequencies) over the multiple time-frequency resources via a subband full-duplex operation. For example, the base station 1104 may sequentially sweep over K1 beams in time while the RIS (i.e., the RIS array 1106) maintains a K2 retro-reflection configuration (while applying the periodicity and the offset for the time-varying control). The RIS may then change a K2 retro-reflection configuration and the base station 804 may again sweep and transmit using K1 beams. The base station 1104 may repeat this process until the RIS completes a sweep over K2 retro-reflection configurations. For instance, at 1116, the base station 1104 may transmit retro-reflection beams 1118, where the retro-reflection beams 1118 may be reflected by the RIS array 1106 back to the base station 1104 based on the periodicity and the offset for time-varying control. The base station 1104 may measure signal strengths of the (translated) retro-reflection beams 1118. In FIG. 11, the check marks near the beams may indicate that a beam has a corresponding signal strength above (or at) a certain threshold and “X” marks near the beams may indicate that a beam has a corresponding signal strength below the certain threshold.

In a third step, the base station 1104 may (1) select new values of K1 and K2, decide (i.e., determine) K1 base station beams and K2 RIS configurations (potentially from another RIS codebook) along with a time-hopping schedule, and continue from the second step described above with further iterations or (2) select an optimal base station beam out of the (translated) retro-reflection beams 1118 based on certain criteria being met (e.g., a signal strength of a beam being above a threshold value). In an example with respect to (1), at 1122, the base station 1104 may transmit subsequent retro-reflection beams 1124, where the subsequent retro-reflection beams 1124 may be different (e.g., narrower, different spatial orientations, etc.) than the retro-reflection beams 1118. In an example with respect to (2), at 1128, the base station 1104 may select a narrowed beam 1130 for communication with a wireless device based on the narrowed beam 1130 having a signal strength above a threshold value. In an example, the narrowed beam 1130 may be one of the subsequent retro-reflection beams 1124 (or one of the retro-reflection beams 1118).

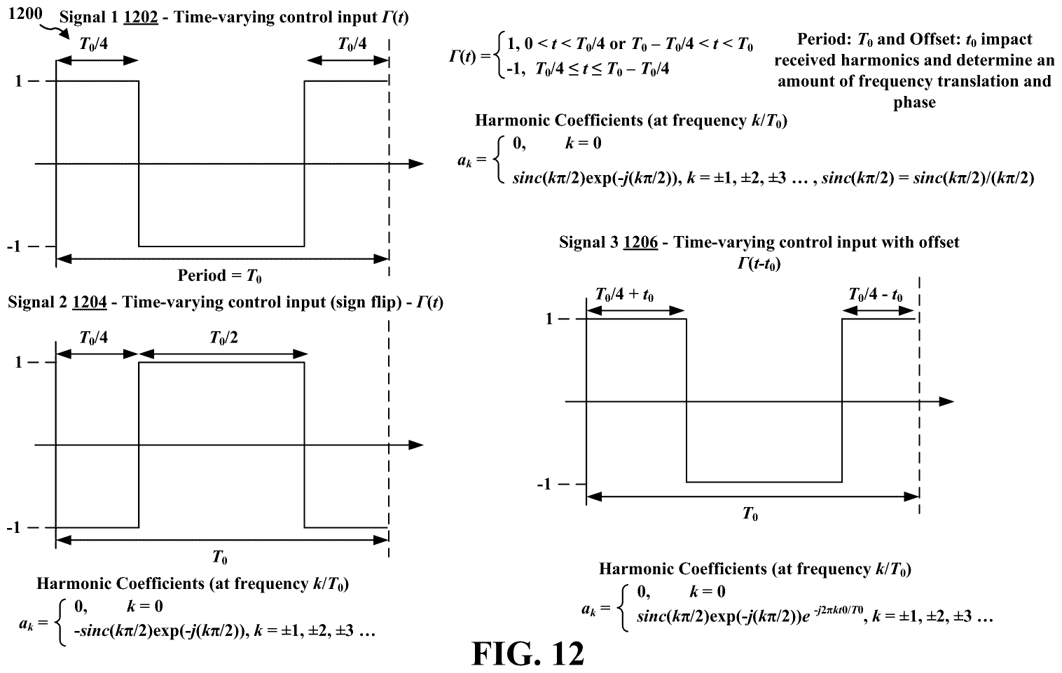

FIG. 12 is a diagram 1200 illustrating example aspects of frequency translation via a time-varying control. The first signal 1202 may be a time varying control input Γ(t). The time varying control input Γ(t) and harmonic coefficients ax (at frequency k/To) for the time varying control input Γ(t) are provided in equations (I) and (II) below, respectively.

$$Γ ( t ) = \{ \begin{matrix}1 , 0 < t < \frac{{T}_{0}}{4} or {T}_{0} - \frac{{T}_{0}}{4} < t < {T}_{0} \\ - 1 , \frac{{T}_{0}}{4} \leq t \leq {T}_{0} - \frac{{T}_{0}}{4}\end{matrix} \qquad ( I )$$

$${a}_{k} = \{ \begin{matrix}0 , k = 0 \\ \begin{matrix}- sin c ( \frac{k π}{2} ) exp ( - j \frac{k π}{2} ) , k = \pm 1 , \pm 2 , \\ \pm 3 … sin c ( \frac{k π}{2} ) = sin ( k π / 2 ) / ( k π / 2 )\end{matrix}\end{matrix} \qquad ( II )$$

The second signal 1204 may be a time varying control input (sign flip)−Γ(t). The harmonic coefficients aₖ (at frequency k/T₀) for the time varying control input (sign flip)-Γ(t) are provided in equation (III) below.

$${a}_{k} = \{ \begin{matrix}0 , k = 0 \\ sin c ( \frac{k π}{2} ) exp ( - j \frac{k π}{2} ) , k = \pm 1 , \pm 2 , \pm 3 …\end{matrix} \qquad ( III )$$

The third signal 1206 may be a time-varying control input with offset Γ(t−t₀). The harmonic coefficients aₖ (at frequency k/T₀) for the time-varying control input with offset Γ(t−t₀) are provided in equation (IV) below.

$${a}_{k} = \{ \begin{matrix}0 , k = 0 \\ - sin c ( \frac{k π}{2} ) exp ( - j \frac{k π}{2} ) {e}^{- j 2 π {kt}_{0} / {T}_{0}} , k = \pm 1 , \pm 2 , \pm 3 …\end{matrix} \qquad ( IV )$$

In equations (I)-(IV), the period (To) and the offset (to) may impact received harmonics and determine an amount of frequency translation and phase. As described above with respect to FIG. 12, a RIS may reflect a beam transmitted by a base station based on the period (To) and the offset (to) in order to achieve frequency translation in a reflected signal. In an example, the first signal 1202, the second signal 1204, and/or the third signal 1206 may be associated with the RIS control sequence 1132, that is, the first signal 1202, the second signal 1204, and/or the third signal 1206 may be utilized by the RIS array 1106 to achieve a frequency translation in a signal reflected by the RIS array 1106 in order to mitigate self-interference at the base station 1104.

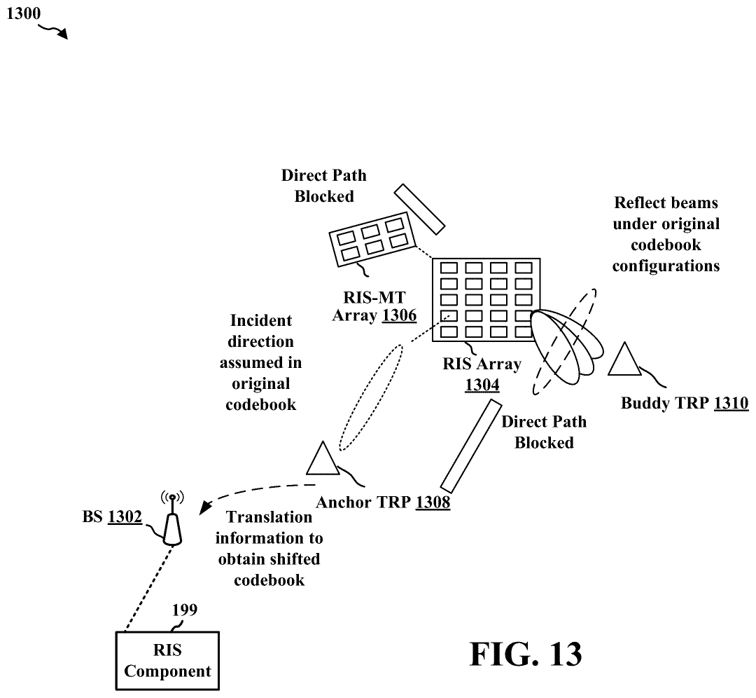

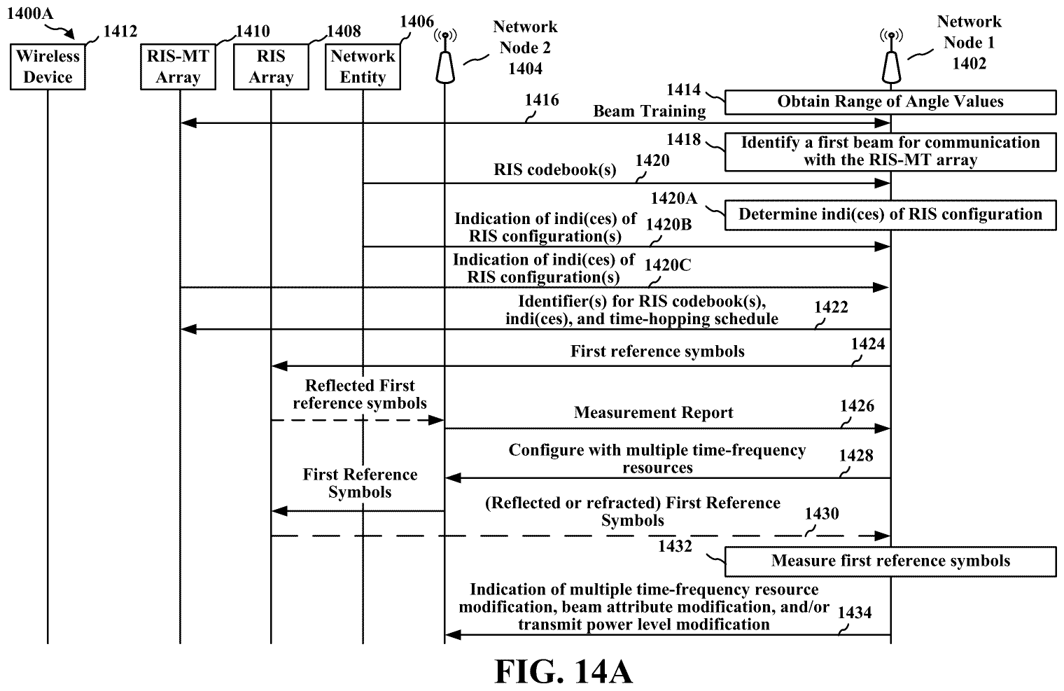

FIG. 13 is a diagram 1300 illustrating example aspects of an initialization scheme for base station to RIS beam refinement. FIG. 13 depicts a base station 1302, a RIS array 1304, a RIS-MT array 1306, an anchor TRP 1308, and a buddy TRP 1310. Although aspects are described for a base station, aspects may be performed by a network node that comprises a base station in aggregation or one or more components of a disaggregated base station. Similarly, the buddy node may refer to a second base station, one or more components of a base station. In some aspects, the base station 804 may correspond to one TRP of a base station and the buddy node may correspond to a second TRP of the base station. A direct path may be blocked between the base station 1302 and the buddy TRP 1310. A network entity (e.g., the base station 1302, the network entity 716) may identify a buddy node (or a buddy TRP), that is, the network entity may identify the buddy TRP 1310. The network entity may determine at least one RIS codebook including RIS configuration(s) for the buddy TRP 1310, where the RIS configuration(s) may achieve anomalous reflections with gains above a threshold for the anchor TRP 1308 to the buddy TRP 1310. The network entity may provide the at least one RIS codebook to the base station 1302 and the RIS-MT array 1306, where the at least one RIS codebook may be derived assuming a source transmitter is the anchor TRP 1308. The network entity may also provide reference point translation information or orientation translation information to the base station 1302 and/or the RIS-MT array 1306, where the reference point translation information or the orientation translation information may be utilized to change a source transmitter incident direction (assumed in the RIS codebook(s)) from the anchor TRP 1308 to the base station 1302. In one example, the network entity may provide reference point translation information or orientation translation information and frequency translation information to the base station 1302 and/or the RIS-MT array 1306, where the reference point translation information or the orientation translation information may be utilized to change a source transmitter incident direction (assumed in the RIS codebook(s)) from the anchor TRP 1308 to the base station 1302, and where the frequency translation information may be used to account for the change in frequency used for communication by the base station via the RIS array. In a scenario in which the network entity provides the reference point translation information or the orientation translation information to the base station 1302 and not the RIS-MT array 1306, the base station 1302 may signal a shift (i.e., a translation) to the RIS-MT array 1306 based on the reference point translation information or the orientation translation information. The RIS-MT array 1306 may be capable of applying the shift (i.e., the translation) onto the RIS codebook(s) and configuring the RIS array 1304 based on the translated RIS codebook(s) (i.e., the RIS codebook(s) that have been shifted/translated).

In one aspect, a network entity may specify one or more RIS configuration codebook(s) (i.e., one or more RIS configurations in one or more RIS codebooks) to the base station 1302. The RIS codebooks may account for an approximate incident signal direction from the base station 1302 to the RIS array 1304, that is, the RIS codebooks may include information that is indicative of the approximate incident signal direction from the base station 1302 to the RIS array 1304. The RIS codebooks may also include information that is indicative of an approximate distance between the base station 1302 and the RIS array 1304. The RIS codebooks may include RIS configurations that achieve anomalous reflections (with gains above a threshold) from an approximate incident direction to the buddy TRP 1310. The RIS codebooks may also include information pertaining to a range of reflected or refracted beam point angles: a set of specific reflect angles and distance ranges for each angle in a set of angles indicating an expected UE (i.e., a wireless device) RX distance along each angle.

In one aspect, a base station may be provided with a range of values to assist in beam training as described above in connection with FIGS. 4A, 4B, and 5-13. In an example, the base station may be provided with a range of angle of arrival (AoA) and/or angle of departure (AoD) values for the base station to search over. Such angular information (i.e., AoA and/or AoD values) may be in absolute terms (i.e., with respect to reference coordinates of a base station) or such angular information may be in relative terms (i.e., with respect to angular information or a beam direction between the base station and a RIS-MT array).

In one aspect, a network entity as described above in connection with any of FIGS. 4A, 4B, and 5-13 may be an OAM, the base station (e.g., a gNB) itself, a centralized unit (CU), another base station (e.g., a second gNB or second network node), or an entity in a core network, such as an LMF. In one aspect pertaining to the base station to RIS beam refinement described above in connection with FIGS. 8-9, when selecting a buddy node, the base station itself may select the buddy node.

In one aspect, a RIS may be associated with a cell/TRP X. In one example, TRP X and buddy TRPs may belong to the same base station-distributed unit (DU), where the DU may make decisions/determinations/selections as described above in connection with any of FIGS. 4A, 4B, and 5-13. In another example, TRP X and buddy TRPs may belong to different base station-DUs of the same base station-CU, where the CU may make decisions/determinations/selections as described above in connection with any of FIGS. 4A, 4B, and 5-13 and/or the CU may share information between two DUs. In an example, the CU may share information on an F1 interface between a CU and a DU. In yet another example, TRP X and buddy TRPs may belong to different base station-CUs, where information may be shared between CUs over an Xn interface.

In one aspect, in the base station to beam refinement techniques described above in connection with FIGS. 8 and 9, an exact reflection direction towards (incident direction from) a buddy node may not be known by a base station. In such an aspect, RIS configurations (e.g., K2 configurations) may be associated with several reflect directions or incident directions. For example, if a location of a RIS is roughly known, a location of a base station and buddy TRP locations may also be known. Given such information, a base station or a network entity may determine a limited range of incident and reflect angles to be searched over in trialed RIS configurations (e.g., trialed K2 configurations).

As described above in connection with FIGS. 8 and 9, a base station may determine a K2 configuration for a RIS. In one aspect, a network entity a RIS-MT array may determine the K2 configurations and the network entity or the RIS-MT array may provide (i.e., transmit) the K2 configurations (or an indication thereof) to the base station. In one example, given a relative distance and an orientation between the RIS-MT array and the RIS array and a beam of the RIS-MT array towards the base station, the RIS-MT array may determine that a RIS may search over several K2 configurations. In another example, given a relative distance and orientation between the RIS-MT array and the RIS array and an operations, administration, and maintenance (OAM) associated with the RIS-MT array, the RIS-MT array may determine that a RIS may search over several K2 configurations. In one aspect, K2 configurations may be determined by a base station, and the base station may be provided with RIS-MT codebook(s) and a relative relation (e.g., a spatial quasi-colocation (QCL)-like relation) between beams of a RIS-MT array and RIS codebook elements.

In one aspect, multi-finger (i.e., multi-lobe) RIS configurations (i.e., a multi-lobe K2 configuration) may be used to increase a speed of a beam search pertaining to the base station to RIS beam refinement techniques described above in connection with FIGS. 8 and 9. For example, each RIS configuration may create G2 (G2 is a positive integer) beam directions towards a base station simultaneously (i.e., K2/G2+1) instead of K2 configurations to be searched over.

In one aspect, a base station (e.g., the base station 804, the base station 904, the base station 1004, etc.) may perform certain actions to avoid selecting a relatively poorly refined beam (i.e., poor local optima). In one aspect, the base station and a buddy node (e.g., the second TRP 812, the second TRP 912, the second TRP 1012, etc.) may iterate between the base station to RIS beam refinement techniques described above in connection with FIG. 8 (buddy node in receive and report mode) and the base station to RIS beam refinement techniques described above in connection with FIG. 9 (buddy node in transmit mode) in order to avoid selecting a relatively poorly refined beam. A network entity or a base station may configure more than one buddy node for the same RIS. The base station may combine beams refined across the more than one buddy node, and the base station may select a beam based on the combined beams in order to avoid selecting a relatively poorly refined beam. In one aspect, a base station may utilize a RIS watermarking technique to imprint a RIS identifier (ID) on RIS reflections (i.e., on beams that are reflected by a RIS-array). The base station may maintain a database of beams indexed by RIS IDs. The base station may utilize the database indexed by the RIS IDs to facilitate (i.e., “to jump start”) beam refinement, which may aid the base station in avoiding selecting a relatively poorly refined beam.

In one aspect, a base station (e.g., the base station 804, the base station 904, the base station 1004, etc.) may select between “buddy-node” based training as described above in connection with FIGS. 8 and 9 or retro-reflection based training as described above in connection with FIGS. 10-12. In an example, a RIS and a base station may support retro-reflection based training. The base station or a network entity may determine whether to utilize retro-reflection based training or buddy-node based training based on a link budget. The link budget may depend on a path loss (as measured by reference signal received power (RSRP), an angular region over which the RIS is capable of retro-reflection, a retro-reflection gain (which may be angle-dependent), etc. In an example, the path loss, the angular region over which the RIS is capable of retroreflection, and the retroreflection gain may be provided to the base station or the network entity, and the network entity may decide whether to utilize retro-reflection based training or buddy-node based training based on such information. In one aspect, a RIS-MT array may transmit a suggestion to the base station or the network entity, and the base station or the network entity may decide whether to utilize retro-reflection based training or buddy-node based training based on the suggestion.

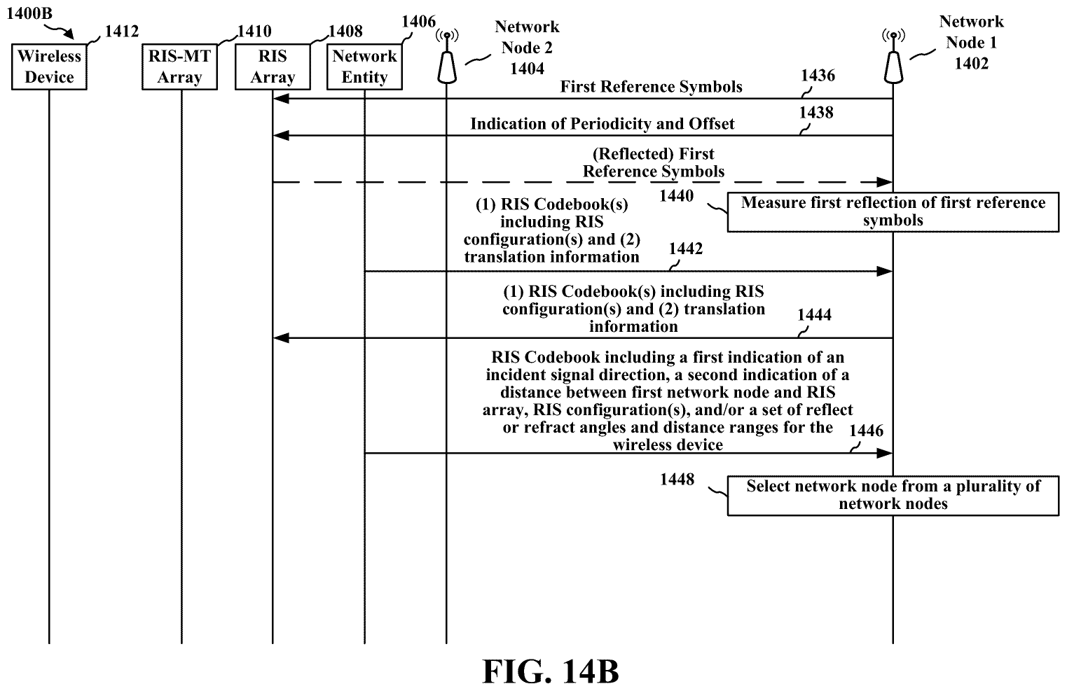

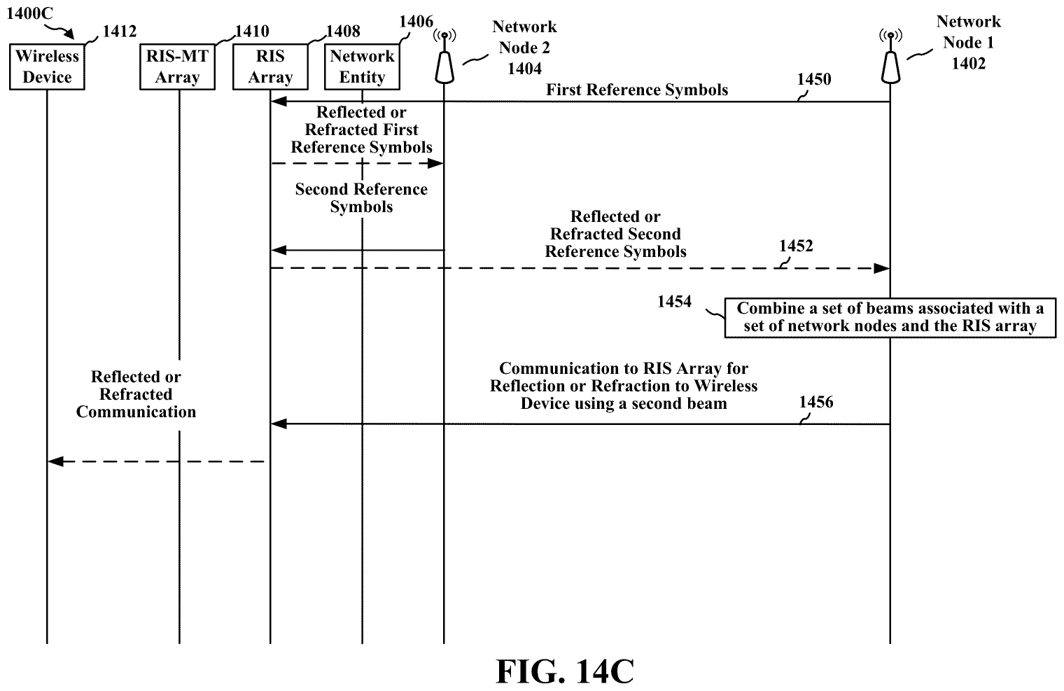

FIG. 14A is a communication flow diagram 1400A illustrating example communications between a first network node 1402, a second network node 1404, a network entity 1406, a RIS array 1408, a RIS-MT array 1410, and a wireless device 1412. FIG. 14B is a communication flow diagram 1400B illustrating example communications between the first network node 1402, the second network node 1404, the network entity 1406, the RIS array 1408, the RIS-MT array 1410, and the wireless device 12. FIG. 14C is a communication flow diagram 1400C illustrating example communications between the first network node 1402, the second network node 1404, the network entity 1406, the RIS array 1408, the RIS-MT array 1410, and the wireless device 12.

Referring now to FIG. 14A, at 1416, the first network node 1402 may perform beam training with the RIS-MT array 1410, where the RIS-MT array 1410 is associated with the RIS array 1408. At 1418, the first network node 1402 may identify, based on the beam training, a first beam for communication with the RIS-MT array 1410. Referring now to FIG. 14C, at 1456, the first network node 1402 may transmit communication to the RIS array 1408 for reflection or refraction to the wireless device 1412 (e.g., a UE) using a second beam based, at least in part, on the first beam identified for the RIS-MT array 1410 (e.g., the first network node 1402 may select a second beam based at least in part on the first beam, and the first network node 1402 may transmit the communication using the second beam). The communication may be refracted or refracted to the wireless device 1412 by the RIS array 1408. In one aspect, the first network node 1402 may also receive communication from the RIS array 1408 using a third beam based, at least in part on the first beam identified for the RIS-MT array 1410, where the third beam is reflected to the first network node 1402 from the wireless device 1412 by the RIS array 1408.

Referring now to FIG. 14A, at 1420, the first network node 1402 may obtain, from the network entity 1406, at least one RIS codebook including at least one RIS configuration for the RIS array 1408. At 1422, the first network node 1402 may transmit, for the RIS-MT array 1410, at least one identifier for the at least one RIS codebook, at least one index of the at least one RIS configuration, and a time-hopping schedule for the at least one RIS configuration for the RIS array 1408 comprised in the at least one RIS codebook, where transmitting the communication to the RIS array 1408 for the reflection or the refraction to the wireless device using the second beam at 1456 may be further based on the at least one identifier for the at least one RIS codebook, the at least one index of the at least one RIS configuration, and the time-hopping schedule. In one aspect, at 1420A, the first network node 1402 may determine the at least one index of the at least one RIS configuration, where transmitting the at least one index of the at least one RIS configuration at 1422 may be based on the determination. In one aspect, at 1420B or 1420C, the first network node 1402 may receive, from the network entity 1406 or the RIS-MT array 1410, an indication of the at least one index of the at least one RIS configuration, where transmitting the at least one index of the at least one RIS configuration at 1422 may be based on the indication of the at least one index of the at least one RIS configuration.

In one aspect, at 1424, the first network node 1402 may transmit first reference symbols to the RIS array 1408 for reflection to the second network node 1404. The first reference symbols may be reflected to the second network node 1404 by the RIS array 1408. At 1426, the first network node 1402 may receive a measurement report of the first reference symbols from the second network node 1404, where transmitting the communication to the RIS array 1408 for the reflection or the refraction to the wireless device 1412 using the second beam at 1456 may be further based on the measurement report of the first reference symbols.

In one aspect, at 1430, the first network node 1402 may receive first reference symbols over multiple time-frequency resources, where the first reference symbols are reflected or refracted to the first network node 1402 by the RIS array 1408 from the second network node 1404. At 1432, the first network node may measure the first reference symbols, where transmitting the communication to the RIS array 1408 for the reflection or the refraction to the wireless device 1412 using the second beam may be further based on the measured first reference symbols. At 1428, the first network node 1402 may configure the second network node 1404 with the multiple time-frequency resources, where receiving the first reference symbols at 1430 may be based on the configuration. At 1434, the first network node 1402 may transmit, for the second network node, at least one of: a first indication that the multiple time-frequency resources are to be modified, a second indication that attributes of a beam associated with the first reference symbols are to be modified, or a third indication that a transmit power level of the beam is to be modified.

Referring now to FIG. 14B, in one aspect, at 1436, the first network node 1402 may transmit, for the RIS array 1408, first reference symbols over multiple time-frequency resources. The first reference symbols may be reflected back to the first network node 1402 by the RIS array 1408. At 1440, the first network node 1402 may measure a first reflection of the first reference symbols, where transmitting the communication to the RIS array 1408 for the reflection or the refraction to the wireless device 1412 using the second beam at 1456 may be further based on the measured first reflection of the first reference symbols. At 1438, the first network node 1402 may transmit an indication of a periodicity and an offset that the RIS array 1408 is to apply during transmission of the first reference symbols over the multiple time-frequency resources, where the reflection of the first reference symbols may be based on the indication of the periodicity and the offset, and where measuring the first reflection of the first reference symbols at 1440 may include measuring the first reflection of the first reference symbols via a subband full-duplex operation.

In one aspect, at 1442, the first network node 1402 may obtain, from the network entity 1406, (1) at least one RIS codebook including at least one RIS configuration associated with a first reflection or a first refraction between the second network node 1404 and a third network node (not depicted in FIG. 14B) with respect to the RIS array 1408 and (2) translation information for changing the first reflection or the first refraction to a second reflection or a second refraction between the second network node 1404 and the first network node with respect to the RIS array 1408. At 1444, the first network node 1402 may transmit, for the RIS array 1408, the at least one RIS codebook and the translation information, where transmitting the communication to the RIS array 1408 for the reflection or the refraction to the wireless device 1412 using the second beam at 1456 may be further based on the at least one RIS codebook and the translation information.

In one aspect, at 1446, the first network node 1402 may obtain, from the network entity 1406, at least one RIS codebook including at least one of: a first indication of an incident signal direction from the first network node to the RIS array 1408, a second indication of a distance between the first network node 1402 and the RIS array 1408, at least one RIS configuration, or a set of reflect or refract angles and distance ranges for the wireless device 1412, where transmitting the communication to the RIS array 1408 for the reflection or the refraction to the wireless device 1412 using the second beam at 1456 may be further based on the first indication, the second indication, the at least one RIS configuration, or the set of reflect or refract angles and the distance ranges.

Referring to FIG. 14A, in one aspect, at 1414, the first network node 1402 may obtain a range of angle values with respect to a reference coordinate of the first network node 1402 or a direction between the first network node 1402 and the RIS-MT array 1410, where performing the beam training with the RIS-MT array 1410 at 1416 may be based on the range of angle values.

Referring to FIG. 14B, in one aspect, at 1448, the first network node 1402 may select a network node from a plurality of network nodes, where transmitting the communication to the RIS array 1408 for the reflection or the refraction to the wireless device 1412 using the second beam at 1456 may be based on first reference symbols received from the network node or second reference symbols transmitted for the network node.

Referring to FIG. 14C, at 1450, the first network node 1402 may transmit first reference symbols over first multiple time-frequency resources to the RIS array 1408 for reflection or refraction to the second network node 1404. At 1452, the first network node 1402 may receive second reference symbols over second multiple time-frequency resources, where the second references symbols may be reflected or refracted to the first network node 1402 by the RIS array 1408 from the second network node 1404, where transmitting the communication to the RIS array 1408 for the reflection or the refraction to the wireless device 1412 using the second beam at 1456 may be further based on transmitted first reference symbols and the received second reference symbols.

In one aspect, the RIS array may be associated with a set of network nodes, and at 1454, the first network node 1402 may combine a set of beams associated with the set of network nodes and the RIS array 1408, where transmitting the communication to the RIS array 1408 for the reflection or the refraction to the wireless device 1412 using the second beam at 1456 may be further based on combined set of beams.

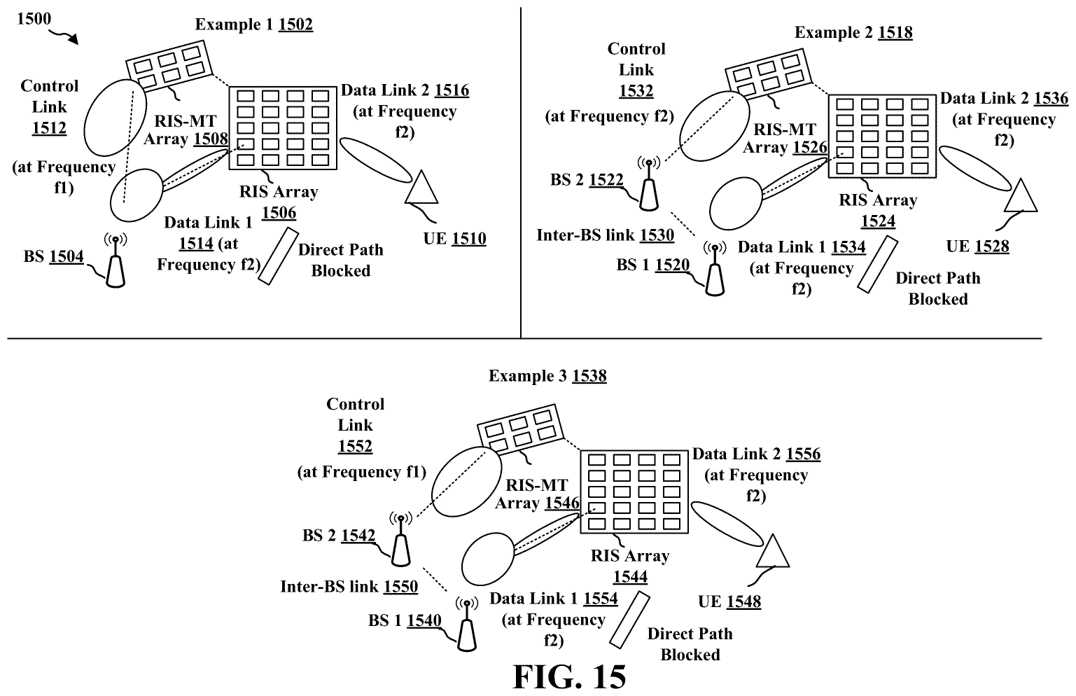

FIG. 15 is a diagram 1500 illustrating example aspects of base station to RIS beam refinement. In a first example 1502, a base station 1504 (e.g., a gNB), a RIS array 1506, a RIS-MT array 1508, and a UE 1510 are depicted. The RIS array 1506 and the RIS-MT array 1508 may be collectively referred to as a RIS. A direct path may be blocked between the base station 1504 and the UE 1510. The base station 1504 and the RIS-MT array 1508 may communicate over a control link 1512, where the control link 1512 may be at a first frequency f1. The base station 1504 may transmit communication for reflection or refraction to the UE 1510 via the RIS array 1506 by way of a first data link 1514, where the first data link 1514 may be at a second frequency f2. The communication may be reflected or refracted to the UE 1510 via the RIS array 1506 by way of a second data link 1516, where the second data link 1516 may be at the second frequency f2, where the second frequency f2 may be different from the first frequency f1. The base station 1504 may control the RIS via the control link 1512. The RIS may assist the base station 1504 to serve the UE 1510. The base station 1504 may translate a beam associated with the control link 1512 (e.g., using translation information) in order for the base station 1504 to obtain a beam associated with the first data link 1514. The translation may change the frequency from f1 to f2. After obtaining the beam associated with the first data link 1514, the base station 1504 may perform further refinements (e.g., the refinements described above) to obtain a more suitable beam in comparison to the beam associated with the first data link 1514.

In a second example 1518, a first base station 1520 (e.g., a first gNB), a second base station 1522 (e.g., a second gNB), a RIS array 1524, a RIS-MT array 1526, and a UE 1528 are depicted. The RIS array 1524 and the RIS-MT array 1526 may be collectively referred to as a RIS. A direct path may be blocked between the first base station 1520 and the UE 1528. The first base station 1520 and the second base station 1522 may communicate over an inter-BS link 1530. The second base station 1522 and the RIS-MT array 1526 may communicate over a control link 1532. The first base station 1520 may transmit communication for reflection or refraction to the UE 1528 via the RIS array 1524 by way of a first data link 1534. The communication may be reflected or refracted to the UE 1528 via the RIS array 1524 by way of a second data link 1536. In one an example, the control link 1532, the first data link 1534, and the second data link 1536 may each be at a first frequency f1 or the control link 1532, the first data link 1534, and the second data link 1536 may each be at a second frequency f2. The second base station 1522 may control the RIS via the control link 1532. The RIS-MT array 1526 may include or may be associated with a RIS controller. The RIS may assist the first base station 1520 to serve the UE 1528. The first base station 1520 and/or the second base station 1522 may translate a beam associated with the control link 1532 to obtain a beam associated with the first data link 1534. After obtaining the beam associated with the first data link 1534, the first base station 1520 may perform further refinements (e.g., the refinements described above) to obtain a more suitable beam in comparison to the beam associated with the first data link 1534. In a first example, a beam refinement for a beam associated with the first base station 1520 and the RIS-MT array 1526 may be guided (i.e., boot-strapped) by information corresponding to the beam associated with the control link 1532 between the second base station 1522 and the RIS-MT array 1526. In a second example, a beam refinement for the beam associated with the first data link 1534 may be directly guided (i.e., boot-strapped) by information corresponding to the beam associated with the control link 1532.

In a third example 1538, a first base station 1540 (e.g., a first gNB), a second base station 1542 (e.g., a second gNB), a RIS array 1544, a RIS-MT array 1546, and a UE 1548 are depicted. The RIS array 1544 and the RIS-MT array 1546 may be collectively referred to as a RIS. A direct path may be blocked between the first base station 1540 and the UE 1548. The first base station 1540 and the second base station 1542 may communicate over an inter-BS link 1550. The second base station 1542 and the RIS-MT array 1546 may communicate over a control link 1552, where the control link 1552 may be at a first frequency f1. The first base station 1540 may transmit communication for reflection or refraction to the UE 1548 via the RIS array 1544 by way of a first data link 1554, where the first data link 1554 may be at a second frequency f2, where the second frequency f2 may be different from the first frequency f1. The communication may be reflected or refracted to the UE 1548 via the RIS array 1544 by way of a second data link 1556, where the second data link 1556 may be at the second frequency f2. The second base station 1542 may control the RIS. The RIS may assist the first base station 1540 to serve the UE 1548. The first base station 1540 and/or the second base station 1542 may translate a beam associated with the control link 1552 to obtain a beam associated with the first data link 1554. The translation may change the frequency from f1 to f2. After obtaining the beam associated with the first data link 1554, the first base station 1540 may perform further refinements (e.g., the refinements described above) to obtain a more suitable beam in comparison to the beam associated with the first data link 1554.

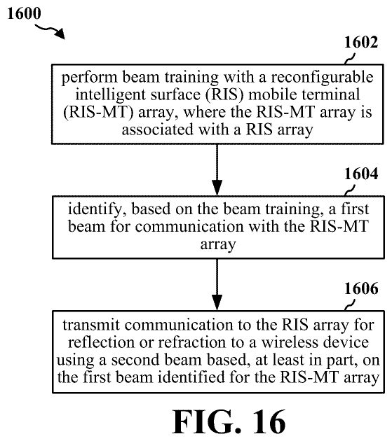

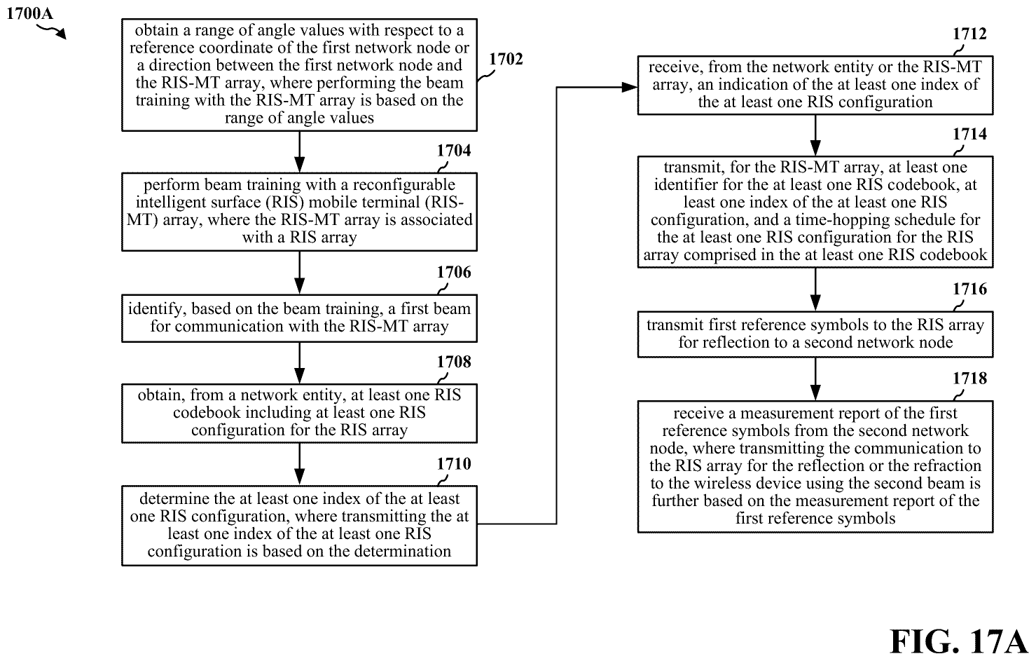

FIG. 16 is a flowchart 1600 of a method of wireless communication. The method may be performed by a first network node (e.g., the base station 102, the base station 310, the base station 402, the base station 502, the base station 604, the base station 702, the base station 804, the base station 904, the base station 1004, the base station 1104, the base station 1302, the first network node 1402, the network entity 1802. 1902, 2060). The method may be associated with various advantages at the first network node, such as optimizing a transmit and/or a receive beam between the first network node and a RIS array so as to provide for increased communications reliability with respect to a wireless device (e.g., a UE). In an example, the method may be performed by the RIS component 199.

At 1602, the first network node performs beam training with a reconfigurable intelligent surface (RIS) mobile terminal (RIS-MT) array, where the RIS-MT array is associated with a RIS array. For example, FIG. 14A at 1416 shows that the first network node 1402 may perform beam training with a RIS-MT array 1410. In an example, the RIS-MT array may be or include the RIS-MT array 608, the RIS-MT array 706, the RIS-MT array 808, the RIS-MT array 908, the RIS-MT array 1008, the RIS-MT array 1108, or the RIS-MT array 1306. In an example, the RIS array may be or include the RIS array 606, the RIS array 704, the RIS array 806, the RIS array 906, the RIS array 1006, the RIS array 1106, or the RIS array 1304. In another example, the RIS-MT array and the RIS array may be associated with the RIS 103, the RIS 406, the RIS 506, or the RIS 2140. In an example, 1602 may be performed by the RIS component 199.

At 1604, the first network node identifies, based on the beam training, a first beam for communication with the RIS-MT array. For example, FIG. 14A at 1418 shows that the first network node 1402 may identify, based on the beam training, a first beam for communication with the RIS-MT array 1410. In an example, the first beam may be the initial beam 712, the initial beam 814, the initial beam 914, the initial beam 1014, or the initial beam 1114. In an example, 1604 may be performed by the RIS component 199.

At 1606, the first network node transmits communication to the RIS array for reflection or refraction to a wireless device using a second beam based, at least in part, on the first beam identified for the RIS-MT array. For example, FIG. 14C at 1456 shows that the first network node 1402 may transmit communication to the RIS array 1408 for reflection or refraction to the wireless device 1412 using a second beam based, at least in part, on the first beam identified for the RIS-MT array 1410. In an example, the second beam may be the updated beam 720, the narrowed beam 830, the narrowed beam 930, the narrowed beam 1030, or the narrowed beam 1130. In an example, 1606 may be performed by the RIS component 199.

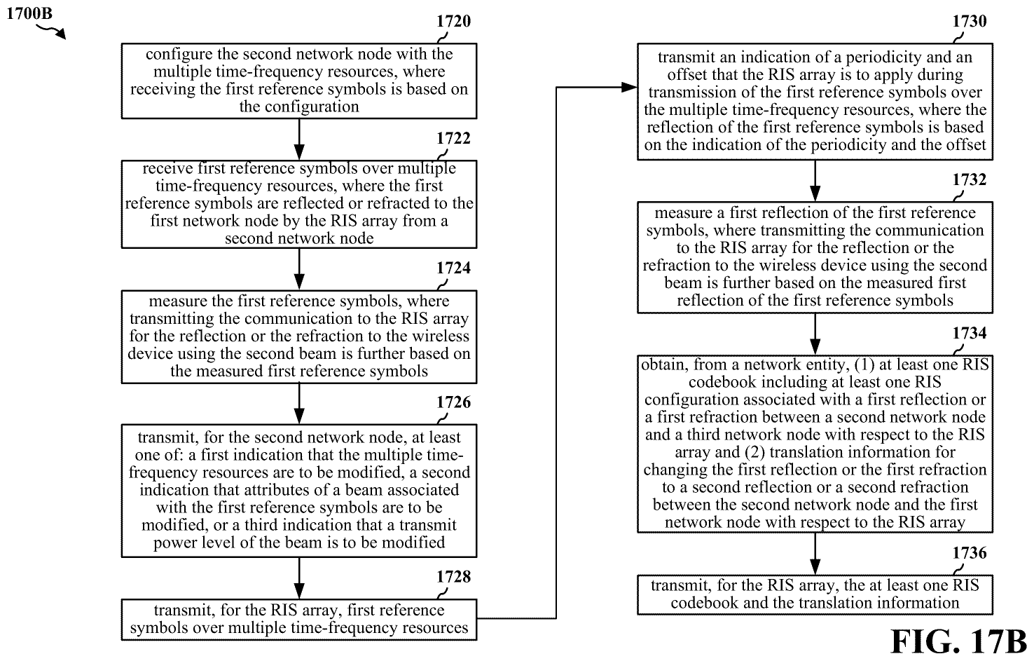

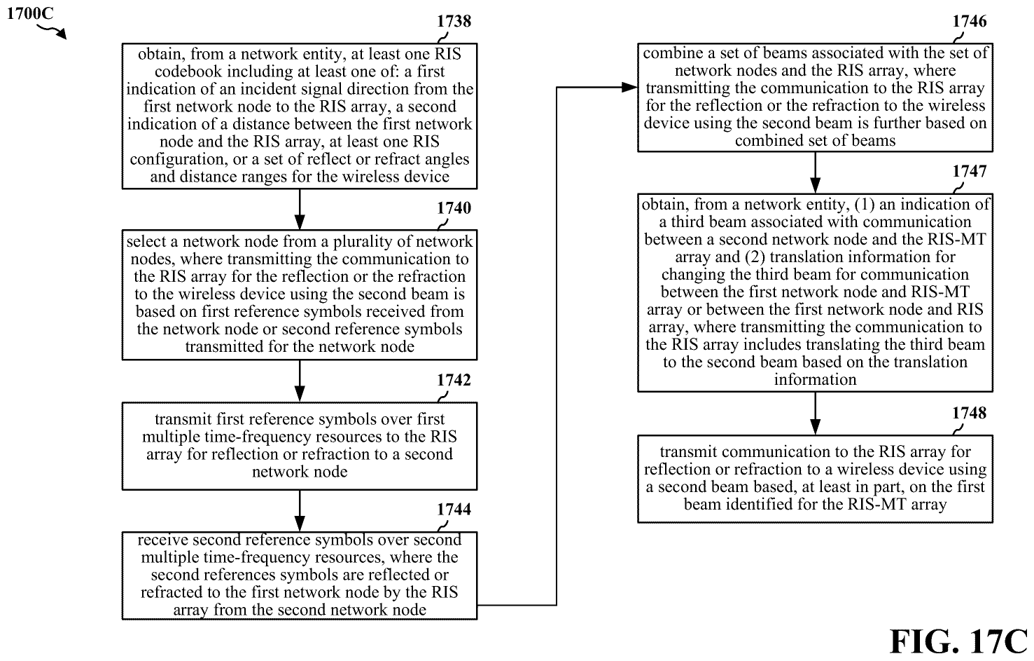

FIG. 17A is a flowchart 1700A of a method of wireless communication. FIG. 17B is a flowchart 1700B of a method of wireless communication. FIG. 17C is a flowchart 1700C of a method of wireless communication. The method in FIG. 17A, FIG. 17B, and/or FIG. 17C may be performed by a first network node (e.g., the base station 102, the base station 310, the base station 402, the base station 502, the base station 604, the base station 702, the base station 804, the base station 904, the base station 1004, the base station 1104, the base station 1302, the first network node 1402, the network entity 1802, 1902, 2060). The method may be associated with various advantages at the first network node, such as optimizing a transmit and/or a receive beam between the first network node and a RIS array so as to provide for increased communications reliability with respect to a wireless device (e.g., a UE). In an example, the method (including the various aspects detailed below) may be performed by the RIS component 199.

Referring now to FIG. 17A, at 1704, the first network node performs beam training with a reconfigurable intelligent surface (RIS) mobile terminal (RIS-MT) array, where the RIS-MT array is associated with a RIS array. For example, FIG. 14A at 1416 shows that the first network node 1402 may perform beam training with a RIS-MT array 1410. In an example, the RIS-MT array may be or include the RIS-MT array 608, the RIS-MT array 706, the RIS-MT array 808, the RIS-MT array 908, the RIS-MT array 1008, the RIS-MT array 1108, or the RIS-MT array 1306. In an example, the RIS array may be or include the RIS array 606, the RIS array 704, the RIS array 806, the RIS array 906, the RIS array 1006, the RIS array 1106, or the RIS array 1304. In another example, the RIS-MT array and the RIS array may be associated with the RIS 103, the RIS 406, the RIS 506, or the RIS 2140. In an example, 1704 may be performed by the RIS component 199.

At 1706, the first network node identifies, based on the beam training, a first beam for communication with the RIS-MT array. For example, FIG. 14A at 1418 shows that the first network node 1402 may identify, based on the beam training, a first beam for communication with the RIS-MT array 1410. In an example, the first beam may be the initial beam 712, the initial beam 814, the initial beam 914, the initial beam 1014, or the initial beam 1114. In an example, 1706 may be performed by the RIS component 199.

Referring now to FIG. 17C, at 1748, the first network node transmits communication to the RIS array for reflection or refraction to a wireless device using a second beam based, at least in part, on the first beam identified for the RIS-MT array. For example, FIG. 14C at 1456 shows that the first network node 1402 may transmit communication to the RIS array 1408 for reflection or refraction to the wireless device 1412 using a second beam based, at least in part, on the first beam identified for the RIS-MT array 1410. In an example, the second beam may be the updated beam 720, the narrowed beam 830, the narrowed beam 930, the narrowed beam 1030, or the narrowed beam 1130. In an example, 1748 may be performed by the RIS component 199.

Referring now to FIG. 17A, in one aspect, at 1708, the first network node may obtain, from a network entity, at least one RIS codebook including at least one RIS configuration for the RIS array. For example, FIG. 14A at 1420 shows that the first network node 1402 may obtain, from the network entity 1406, at least one RIS codebook including at least one RIS configuration for the RIS array 1408. In an example, 1708 may be performed by the RIS component 199.

In one aspect, at 1714, the first network node may transmit, for the RIS-MT array, at least one identifier for the at least one RIS codebook, at least one index of the at least one RIS configuration, and a time-hopping schedule for the at least one RIS configuration for the RIS array included in the at least one RIS codebook, where transmitting the communication to the RIS array for the reflection or the refraction to the wireless device using the second beam may be further based on the at least one identifier for the at least one RIS codebook, the at least one index of the at least one RIS configuration, and the time-hopping schedule. For example, FIG. 14A at 1422 shows that the first network node 1402 may transmit, for the RIS-MT array 1410, at least one identifier for the at least one RIS codebook, at least one index of the at least one RIS configuration, and a time-hopping schedule for the at least one RIS configuration for the RIS array 1408 included in the at least one RIS codebook, where transmitting the communication to the RIS array 1408 for the reflection or the refraction to the wireless device 1412 using the second beam at 1456 may be further based on the at least one identifier for the at least one RIS codebook, the at least one index of the at least one RIS configuration, and the time-hopping schedule. In an example, 1714 may be performed by the RIS component 199.

In one aspect, the network entity may be one of the first network node, a second network node, a core network entity, a centralized unit (CU), or an operations, administration, and maintenance (OAM) entity. For example, the network entity 1406 may be the first network node 1402, the second network node 1404, an entity associated with the core network 120, the CU 1910, or an OAM entity.

In one aspect, the at least one RIS configuration may indicate a plurality of reflection directions or refraction directions or incident directions. For example, the at least one RIS configuration transmitted at 1422 may indicate a plurality of reflection directions or refraction directions or incident directions. In another example, the plurality of reflection directions or refraction directions or incident directions may be associated with any of 510a, 510b, 510c, 510d, 510e, or 510f.

In one aspect, the at least one RIS configuration may include at least one multiple lobe RIS configuration. For example, the at least one RIS configuration transmitted at 1422 may include at least one multiple lobe RIS configuration.

In one aspect, the at least one RIS configuration may include one of a plurality of K2 configurations. For example, the at least one RIS configuration transmitted at 1422 may include one of a plurality of K2 configurations.

In one aspect, at 1710, the first network node may determine the at least one index of the at least one RIS configuration, where transmitting the at least one index of the at least one RIS configuration may be based on the determination. For example, FIG. 14A at 1420A shows that the first network node 1402 may determine the at least one index of the at least one RIS configuration, where transmitting the at least one index of the at least one RIS configuration at 1422 may be based on the determination. In an example, 1710 may be performed by the RIS component 199.

In one aspect, at 1712, the first network node may receive, from the network entity or the RIS-MT array, an indication of the at least one index of the at least one RIS configuration, where transmitting the at least one index of the at least one RIS configuration may be based on the indication of the at least one index of the at least one RIS configuration. For example, FIG. 14A at 1420B or 1430C shows that the first network node 1402 may receive, from the network entity 1406 or the RIS-MT array 1410, an indication of the at least one index of the at least one RIS configuration, where transmitting the at least one index of the at least one RIS configuration at 1422 may be based on the indication of the at least one index of the at least one RIS configuration. In an example, 1712 may be performed by the RIS component 199.

In one aspect, the second beam for the communication to the RIS array may be based on the first beam identified for the RIS-MT array and translation information for the RIS array relative to the RIS-MT array, where the first beam may be associated with a first frequency and the second beam may be associated with a second frequency due to the translation information. For example, the translation information may be the translation information 718. In an example, the aforementioned aspect may correspond to the description of FIG. 7. In another example, the aforementioned aspect may correspond to the first example 1502.

In one aspect, at 1716, the first network node may transmit first reference symbols to the RIS array for reflection to a second network node. For example, FIG. 14A at 1424 shows that the first network node 1402 may transmit first reference symbols to the RIS array 1408 for reflection to the second network node 1404. In an example, the second network node may be the second TRP 812. The second network node may be a buddy node. The aforementioned aspect may correspond to the description of FIG. 8. In an example, 1716 may be performed by the RIS component 199.

In one aspect, at 1718, the first network node may receive a measurement report of the first reference symbols from the second network node, where transmitting the communication to the RIS array for the reflection or the refraction to the wireless device using the second beam may be further based on the measurement report of the first reference symbols. For example, FIG. 14A at 1426 shows that the first network node 1402 may receive a measurement report of the first reference symbols from the second network node, where transmitting the communication to the RIS array 1408 for the reflection or the refraction to the wireless device 1412 using the second beam at 1456 may be further based on the measurement report of the first reference symbols. In an example, the second network node may be the second TRP 812. The aforementioned aspect may correspond to the description of FIG. 8. In an example, 1718 may be performed by the RIS component 199.

In one aspect, the first reference symbols may be transmitted over multiple time-frequency resources. For example, the first reference symbols transmitted at 1424 may be transmitted over multiple time-frequency resources. The aforementioned aspect may correspond to the description of FIG. 8.

In one aspect, the first reference symbols may be frequency division multiplexed over multiple beams, where the measurement report may further include time-frequency identifiers and measured signal strengths for the multiple beams, and where transmitting the communication to the RIS array for the reflection or the refraction to the wireless device using the second beam may be further based on the time-frequency identifiers and the measured signal strengths. For example, the first reference symbols transmitted at 1424 may be frequency division multiplexed over multiple beams, where the measurement report received at 1426 may further include time-frequency identifiers and measured signal strengths for the multiple beams, and where transmitting the communication to the RIS array 1408 for the reflection or the refraction to the wireless device 1412 using the second beam at 1456 may be further based on the time-frequency identifiers and the measured signal strengths. In an example, the multiple beams may be or include the trial base station Tx beams 820 or the subsequent trial base station Tx beams 824.

Referring now to FIG. 17B, in one aspect, at 1722, the first network node may receive first reference symbols over multiple time-frequency resources, where the first reference symbols may be reflected or refracted to the first network node by the RIS array from a second network node. For example, FIG. 14A at 1430 shows that the first network node may receive first reference symbols over multiple time-frequency resources, where the first reference symbols may be reflected or refracted to the first network node 1402 by the RIS array 1408 the second network node 1404. In an example, the second network node may be the second TRP 912. The aforementioned aspect may correspond to the description of FIG. 9. In an example, 1722 may be performed by the RIS component 199.

In one aspect, at 1724, the first network node may measure the first reference symbols, where transmitting the communication to the RIS array for the reflection or the refraction to the wireless device using the second beam may be further based on the measured first reference symbols. For example, FIG. 14A at 1432 shows that the first network node 1402 may measure the first reference symbols, where transmitting the communication to the RIS array 1408 for the reflection or the refraction to the wireless device 1412 using the second beam at 1456 may be further based on the measured first reference symbols. The aforementioned aspect may correspond to the description of FIG. 9. In an example, 1724 may be performed by the RIS component 199.

In one aspect, at 1720, the first network node may configure the second network node with the multiple time-frequency resources, where receiving the first reference symbols may be based on the configuration. For example, FIG. 14A at 1428 shows that the first network node 1402 may configure the second network node 1404 with the multiple time-frequency resources, where receiving the first reference symbols at 1430 may be based on the configuration. The aforementioned aspect may correspond to the description of FIG. 9. In an example, the second network node may be the second TRP 912. In an example, 1720 may be performed by the RIS component 199. In one aspect, at 1726, the first network node may transmit, for the second network node, at least one of: a first indication that the multiple time-frequency resources are to be modified, a second indication that attributes of a beam associated with the first reference symbols are to be modified, or a third indication that a transmit power level of the beam is to be modified. For example, FIG. 14A at 1434 shows that the first network node 1402 may transmit, for the second network node 1404, at least one of: a first indication that the multiple time-frequency resources are to be modified, a second indication that attributes of a beam associated with the first reference symbols are to be modified, or a third indication that a transmit power level of the beam is to be modified. The aforementioned aspect may correspond to the description of FIG. 9. In an example, the second network node may be the second TRP 912. In an example, 1726 may be performed by the RIS component 199.

In one aspect, at 1728, the first network node may transmit, for the RIS array, first reference symbols over multiple time-frequency resources. For example, FIG. 14B at 1436 shows that the first network node 1402 may transmit, for the RIS array 1408, first reference symbols over multiple time-frequency resources. The aforementioned aspect may correspond to the description of FIG. 10. In an example, 1728 may be performed by the RIS component 199.

In one aspect, at 1732, the first network node may measure a first reflection of the first reference symbols, where transmitting the communication to the RIS array for the reflection or the refraction to the wireless device using the second beam may be further based on the measured first reflection of the first reference symbols. For example, FIG. 14B at 1440 shows that the first network node 1402 may measure a first reflection of the first reference symbols, where transmitting the communication to the RIS array 1408 for the reflection or the refraction to the wireless device 1412 using the second beam at 1456 may be further based on the measured first reflection of the first reference symbols. The aforementioned aspect may correspond to the description of FIG. 10. In an example, 1732 may be performed by the RIS component 199.

In one aspect, measuring the reflection of the first reference symbols may include measuring the reflection of the first reference symbols via a full-duplex operation. For example, measuring the reflection of the first reference symbols at 1440 may include measuring the reflection of the first reference symbols via a full-duplex operation. The aforementioned aspect may correspond to the description of FIG. 10. In one aspect, at 1730, the first network node may transmit an indication of a periodicity and an offset that the RIS array is to apply during transmission of the first reference symbols over the multiple time-frequency resources, where the reflection of the first reference symbols may be based on the indication of the periodicity and the offset, and where measuring the first reflection of the first reference symbols may include measuring the first reflection of the first reference symbols via a subband full-duplex operation. For example, FIG. 14B at 1438 shows that the first network node 1402 may transmit an indication of a periodicity and an offset that the RIS array 1408 is to apply during transmission of the first reference symbols over the multiple time-frequency resources, where the reflection of the first reference symbols may be based on the indication of the periodicity and the offset, and where measuring the first reflection of the first reference symbols at 1440 may include measuring the first reflection of the first reference symbols via a subband full-duplex operation. The aforementioned aspect may correspond to the description of FIG. 11 and FIG. 12. In an example, the periodicity may be associated with the period (To) in FIG. 12 and the offset may be associated with the offset (10) in FIG. 12. In an example, 1730 may be performed by the RIS component 199.

In one aspect, at 1734, the first network node may obtain, from a network entity, (1) at least one RIS codebook including at least one RIS configuration associated with a first reflection or a first refraction between a second network node and a third network node with respect to the RIS array and (2) translation information for changing the first reflection or the first refraction to a second reflection or a second refraction between the second network node and the first network node with respect to the RIS array. For example, FIG. 14B at 1442 shows that the first network node 1402 may obtain, from the network entity 1406, (1) at least one RIS codebook including at least one RIS configuration associated with a first reflection or a first refraction between the second network node 1404 and a third network node (not shown in FIG. 14B) with respect to the RIS array 1408 and (2) translation information for changing the first reflection or the first refraction to a second reflection or a second refraction between the second network node 1404 and the first network node 1402 with respect to the RIS array 1408. The aforementioned aspect may correspond to the description of FIG. 13. In an example, the second network node may be the buddy TRP 1310 and the third network node may be the anchor TRP 1308. In an example, 1734 may be performed by the RIS component 199.

In one aspect, at 1736, the first network node may transmit, for the RIS array, the at least one RIS codebook and the translation information, where transmitting the communication to the RIS array for the reflection or the refraction to the wireless device using the second beam may be further based on the at least one RIS codebook and the translation information. For example, FIG. 14B at 1444 shows that the first network node 1402 may transmit, for the RIS array 1408, the at least one RIS codebook and the translation information, where transmitting the communication to the RIS array 1408 for the reflection or the refraction to the wireless device 1412 using the second beam at 1456 may be further based on the at least one RIS codebook and the translation information. The aforementioned aspect may correspond to the description of FIG. 13. In an example, 1736 may be performed by the RIS component 199.

Referring now to FIG. 17C, in one aspect, at 1738, the first network node may obtain, from a network entity, at least one RIS codebook including at least one of: a first indication of an incident signal direction from the first network node to the RIS array, a second indication of a distance between the first network node and the RIS array, at least one RIS configuration, or a set of reflect or refract angles and distance ranges for the wireless device, where transmitting the communication to the RIS array for the reflection or the refraction to the wireless device using the second beam may be further based on the first indication, the second indication, the at least one RIS configuration, or the set of reflect or refract angles and the distance ranges. For example, FIG. 14B at 1446 shows that the first network node 1402 may obtain, from the network entity 1406, at least one RIS codebook including at least one of: a first indication of an incident signal direction from the first network node 1402 to the RIS array 1408, a second indication of a distance between the first network node 1402 and the RIS array 1408, at least one RIS configuration, or a set of reflect or refract angles and distance ranges for the wireless device 1412, where transmitting the communication to the RIS array 1408 for the reflection or the refraction to the wireless device 1412 using the second beam may be further based on the first indication, the second indication, the at least one RIS configuration, or the set of reflect or refract angles and the distance ranges. The aforementioned aspect may correspond to the description of FIG. 13. In an example, 1738 may be performed by the RIS component 199.

Referring now to FIG. 17A, in one aspect, at 1702, the first network node may obtain a range of angle values with respect to a reference coordinate of the first network node or a direction between the first network node and the RIS-MT array, where performing the beam training with the RIS-MT array may be based on the range of angle values. For example, FIG. 14A at 1414 shows that the first network node 1402 may obtain a range of angle values with respect to a reference coordinate of the first network node 1402 or a direction between the first network node 1402 and the RIS-MT array 1410, where performing the beam training with the RIS-MT array 1410 at 1416 may be based on the range of angle values. In an example, 1702 may be performed by the RIS component 199.

Referring now to FIG. 17C, in one aspect, at 1740, the first network node may select a network node from a plurality of network nodes, where transmitting the communication to the RIS array for the reflection or the refraction to the wireless device using the second beam may be based on first reference symbols received from the network node or second reference symbols transmitted for the network node. For example, FIG. 14B at 1448 shows that the first network node 1402 may select a network node from a plurality of network nodes, where transmitting the communication to the RIS array 1408 for the reflection or the refraction to the wireless device 1412 using the second beam may be based on first reference symbols received from the network node or second reference symbols transmitted for the network node. In an example, the plurality of network nodes may include the first TRP 810 and the second TRP 812, and the (selected) network node may be one of the first TRP 810 or the second TRP 812. In another example, the plurality of network nodes may include the first TRP 910 and the second TRP 912, and the (selected) network node may be one of the first TRP 910 or the second TRP 912. In an example, 1740 may be performed by the RIS component 199.

In one aspect, the network node and the RIS array may belong to a same distributed unit (DU), the network node and the RIS array may belong to different distributed units (DUs) of a same centralized unit (CU), or the network node and the RIS array may belong to different centralized units (CUs). For example, the network node and the RIS array 1408 may both belong to the DU 1930, the network node and the RIS array 1408 may belong to different DUs associated with the CU 1910, or the network node and the RIS array 1408 may belong to different CUs.

In one aspect, the network node may be the first network node or a second network node, and selecting the network node may include selecting the network node based on a link budget associated with the RIS array. For example, the network node may be the first network node 1402 or the second network node 1404, and selecting the network node at 1448 may include selecting the network node based on a link budget associated with the RIS array 1408.

In one aspect, at 1742, the first network node may transmit first reference symbols over first multiple time-frequency resources to the RIS array for reflection or refraction to a second network node. For example, FIG. 14C at 1450 shows that the first network node 1402 may transmit first reference symbols over first multiple time-frequency resources to the RIS array 1408 for reflection or refraction to the second network node 1404. The aforementioned aspect may correspond to the description of FIG. 8 and FIG. 9. In an example, the second network node may be the second TRP 812 or the second TRP 912. In an example, 1742 may be performed by the RIS component 199.

In one aspect, at 1744, the first network node may receive second reference symbols over second multiple time-frequency resources, where the second references symbols may be reflected or refracted to the first network node by the RIS array from the second network node, where transmitting the communication to the RIS array for the reflection or the refraction to the wireless device using the second beam may be further based on transmitted first reference symbols and the received second reference symbols. For example, FIG. 14C at 1452 shows that the first network node 1402 may receive second reference symbols over second multiple time-frequency resources, where the second references symbols may be reflected or refracted to the first network node 1402 by the RIS array 1408 from the second network node 1404, where transmitting the communication to the RIS array 1408 for the reflection or the refraction to the wireless device 1412 using the second beam at 1456 may be further based on transmitted first reference symbols and the received second reference symbols. The aforementioned aspect may correspond to the description of FIG. 8 and FIG. 9. In an example, the second network node may be the second TRP 812 or the second TRP 912. In an example, 1744 may be performed by the RIS component 199.

In one aspect, the RIS array may be associated with a set of network nodes, and at 1746, the first network node may combine a set of beams associated with the set of network nodes and the RIS array, where transmitting the communication to the RIS array for the reflection or the refraction to the wireless device using the second beam may be further based on combined set of beams. For example, the RIS array 1408 may be associated with a set of network nodes, and FIG. 14C at 1454 shows that the first network node 1402 may combine a set of beams associated with the set of network nodes and the RIS array 1408, where transmitting the communication to the RIS array 1408 for the reflection or the refraction to the wireless device 1412 using the second beam may be further based on combined set of beams. In an example, 1746 may be performed by the RIS component 199.

In one aspect, at 1747, the first network node may obtain, from a network entity, (1) an indication of a third beam associated with communication between a second network node and the RIS-MT array and (2) translation information for changing the third beam for communication between the first network node and RIS-MT array or between the first network node and RIS array, where transmitting the communication to the RIS array includes translating the third beam to the second beam based on the translation information. In an example, the aforementioned aspect may correspond to the second example 1518 and/or the third example 1538. In an example, 1747 may be performed by the RIS component 199.

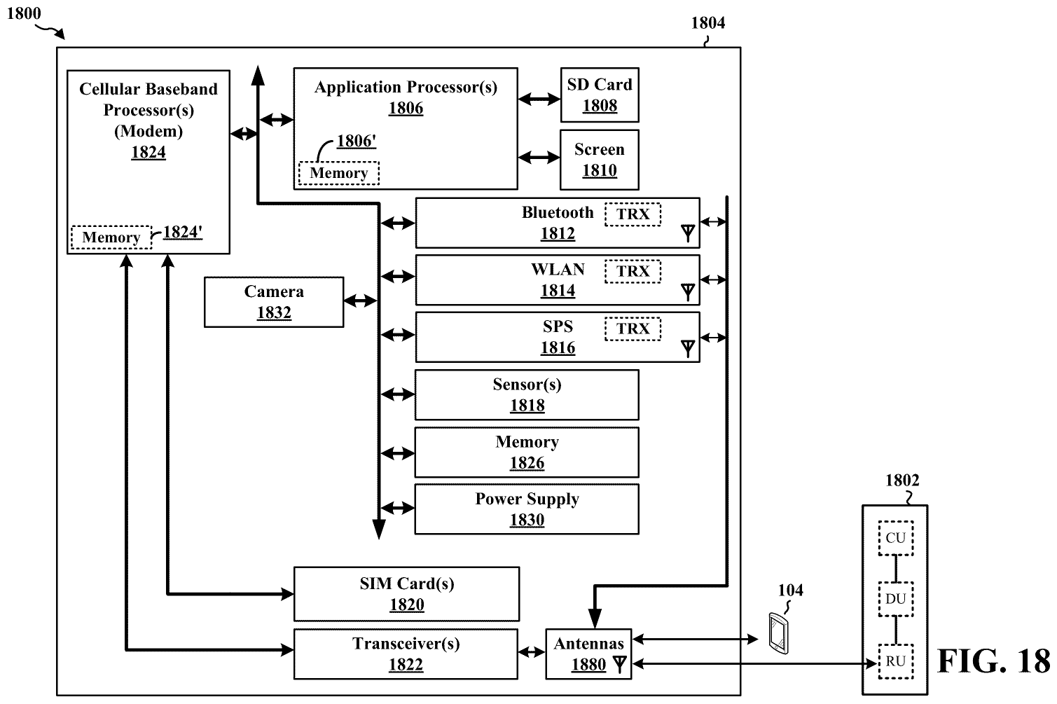

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include at least one cellular baseband processor 1824 (also referred to as a modem) coupled to one or more transceivers 1822 (e.g., cellular RF transceiver). The cellular baseband processor(s) 1824 may include at least one on-chip memory 1824′. In some aspects, the apparatus 1804 may further include one or more subscriber identity modules (SIM) cards 1820 and at least one application processor 1806 coupled to a secure digital (SD) card 1808 and a screen 1810. The application processor(s) 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor(s) 1824 communicates through the transceiver(s) 1822 via one or more antennas 1880 with the UE 104 and/or with an RU associated with a network entity 1802. The cellular baseband processor(s) 1824 and the application processor(s) 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor(s) 1824 and the application processor(s) 1806 are each responsible for general processing, including the execution of software stored on the computer-readable medium/memory. The software, when executed by the cellular baseband processor(s) 1824/application processor(s) 1806, causes the cellular baseband processor(s) 1824/application processor(s) 1806 to perform the various functions described supra. The computer-readable medium/memory may also be used for storing data that is manipulated by the cellular baseband processor(s) 1824/application processor(s) 1806 when executing software. The cellular baseband processor(s) 1824/application processor(s) 1806 may be a component of the UE 350 and may include the at least one memory 360 and/or at least one of the TX processor 368, the RX processor 356, and the controller/processor 359. In one configuration, the apparatus 1804 may be at least one processor chip (modem and/or application) and include just the cellular baseband processor(s) 1824 and/or the application processor(s) 1806, and in another configuration, the apparatus 1804 may be the entire UE (e.g., see UE 350 of FIG. 3) and include the additional modules of the apparatus 1804.

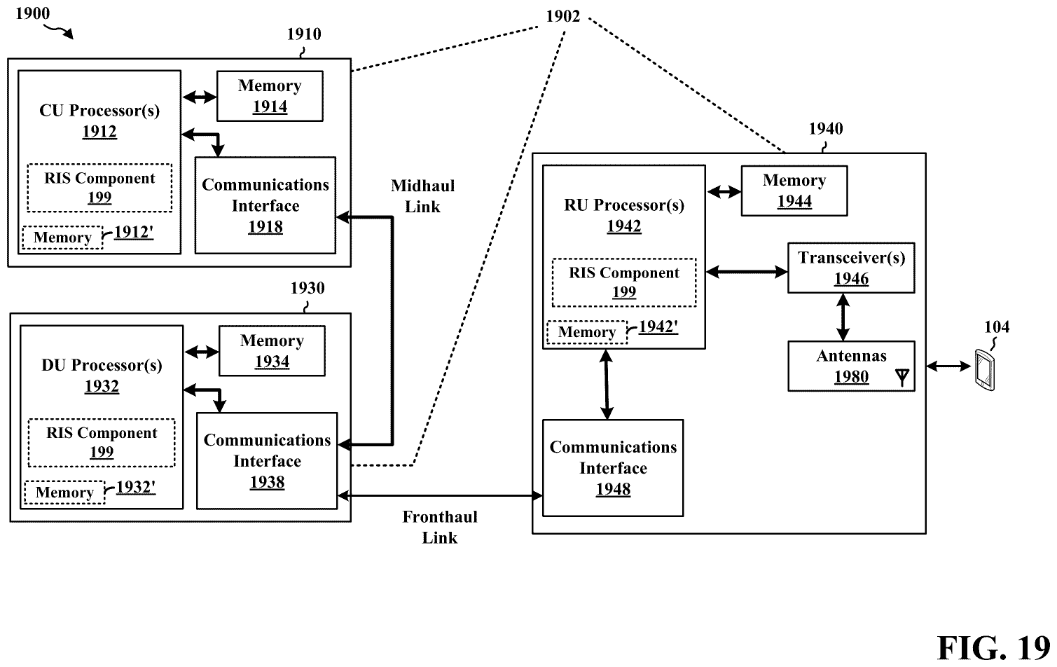

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the RIS component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include at least one CU processor 1912. The CU processor(s) 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include at least one DU processor 1932. The DU processor(s) 1932 may include on-chip memory 1932′. In some aspects, the DU 1930 may further include additional memory modules 1934 and a communications interface 1938. The DU 1930 communicates with the RU 1940 through a fronthaul link. The RU 1940 may include at least one RU processor 1942. The RU processor(s) 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the RIS component 199 may be configured to perform beam training with a reconfigurable intelligent surface (RIS) mobile terminal (RIS-MT) array, where the RIS-MT array is associated with a RIS array. The RIS component 199 may be configured to identify, based on the beam training, a first beam for communication with the RIS-MT array. The RIS component 199 may be configured to transmit communication to the RIS array for reflection or refraction to a wireless device using a second beam based, at least in part, on the first beam identified for the RIS-MT array. The RIS component 199 may be configured to obtain, from a network entity, at least one RIS codebook including at least one RIS configuration for the RIS array. The RIS component 199 may be configured to transmit, for the RIS-MT array, at least one identifier for the at least one RIS codebook, at least one index of the at least one RIS configuration, and a time-hopping schedule for the at least one RIS configuration for the RIS array comprised in the at least one RIS codebook, where transmitting the communication to the RIS array for the reflection or the refraction to the wireless device using the second beam is further based on the at least one identifier for the at least one RIS codebook, the at least one index of the at least one RIS configuration, and the time-hopping schedule. The RIS component 199 may be configured to receive, from the network entity or the RIS-MT array, an indication of the at least one index of the at least one RIS configuration, where transmitting the at least one index of the at least one RIS configuration is based on the indication of the at least one index of the at least one RIS configuration. The RIS component 199 may be configured to determine the at least one index of the at least one RIS configuration, where transmitting the at least one index of the at least one RIS configuration is based on the determination. The RIS component 199 may be configured to transmit first reference symbols to the RIS array for reflection to a second network node. The RIS component 199 may be configured to receive a measurement report of the first reference symbols from the second network node, where transmitting the communication to the RIS array for the reflection or the refraction to the wireless device using the second beam is further based on the measurement report of the first reference symbols. The RIS component 199 may be configured to receive first reference symbols over multiple time-frequency resources, where the first reference symbols are reflected or refracted to the first network node by the RIS array from a second network node. The RIS component 199 may be configured to obtain, from a network entity, (1) an indication of a third beam associated with communication between a second network node and the RIS-MT array and (2) translation information for changing the third beam for communication between the first network node and RIS-MT array or between the first network node and RIS array, where transmitting the communication to the RIS array includes translating the third beam to the second beam based on the translation information. The RIS component 199 may be configured to measure the first reference symbols, where transmitting the communication to the RIS array for the reflection or the refraction to the wireless device using the second beam is further based on the measured first reference symbols. The RIS component 199 may be configured to configure the second network node with the multiple time-frequency resources, where receiving the first reference symbols is based on the configuration. The RIS component 199 may be configured to transmit, for the second network node, at least one of: a first indication that the multiple time-frequency resources are to be modified, a second indication that attributes of a beam associated with the first reference symbols are to be modified, or a third indication that a transmit power level of the beam is to be modified. The RIS component 199 may be configured to transmit, for the RIS array, first reference symbols over multiple time-frequency resources. The RIS component 199 may be configured to measure a first reflection of the first reference symbols, where transmitting the communication to the RIS array for the reflection or the refraction to the wireless device using the second beam is further based on the measured first reflection of the first reference symbols. The RIS component 199 may be configured to transmit an indication of a periodicity and an offset that the RIS array is to apply during transmission of the first reference symbols over the multiple time-frequency resources, where the reflection of the first reference symbols is based on the indication of the periodicity and the offset, and where measuring the first reflection of the first reference symbols includes measuring the first reflection of the first reference symbols via a subband full-duplex operation. The RIS component 199 may be configured to obtain, from a network entity, (1) at least one RIS codebook including at least one RIS configuration associated with a first reflection or a first refraction between a second network node and a third network node with respect to the RIS array and (2) translation information for changing the first reflection or the first refraction to a second reflection or a second refraction between the second network node and the first network node with respect to the RIS array. The RIS component 199 may be configured to transmit, for the RIS array, the at least one RIS codebook and the translation information, where transmitting the communication to the RIS array for the reflection or the refraction to the wireless device using the second beam is further based on the at least one RIS codebook and the translation information. The RIS component 199 may be configured to obtain, from a network entity, at least one RIS codebook including at least one of: a first indication of an incident signal direction from the first network node to the RIS array, a second indication of a distance between the first network node and the RIS array, at least one RIS configuration, or a set of reflect or refract angles and distance ranges for the wireless device, where transmitting the communication to the RIS array for the reflection or the refraction to the wireless device using the second beam is further based on the first indication, the second indication, the at least one RIS configuration, or the set of reflect or refract angles and the distance ranges. The RIS component 199 may be configured to obtain a range of angle values with respect to a reference coordinate of the first network node or a direction between the first network node and the RIS-MT array, where performing the beam training with the RIS-MT array is based on the range of angle values. The RIS component 199 may be configured to select a network node from a plurality of network nodes, where transmitting the communication to the RIS array for the reflection or the refraction to the wireless device using the second beam is based on first reference symbols received from the network node or second reference symbols transmitted for the network node. The RIS component 199 may be configured to transmit first reference symbols over first multiple time-frequency resources to the RIS array for reflection or refraction to a second network node. The RIS component 199 may be configured to receive second reference symbols over second multiple time-frequency resources, where the second references symbols are reflected or refracted to the first network node by the RIS array from the second network node, where transmitting the communication to the RIS array for the reflection or the refraction to the wireless device using the second beam is further based on transmitted first reference symbols and the received second reference symbols. The RIS component 199 may be configured to combine a set of beams associated with the set of network nodes and the RIS array, where transmitting the communication to the RIS array for the reflection or the refraction to the wireless device using the second beam is further based on combined set of beams. The RIS component 199 may be within one or more processors of one or more of the CU 1910, DU 1930, and the RU 1940. The RIS component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1902 may include a variety of components configured for various functions. In one configuration, the network entity 1902 may include means for performing beam training with a reconfigurable intelligent surface (RIS) mobile terminal (RIS-MT) array, where the RIS-MT array is associated with a RIS array. In one configuration, the network entity 1902 may include means for identifying, based on the beam training, a first beam for communication with the RIS-MT array. In one configuration, the network entity 1902 may include means for transmitting communication to the RIS array for reflection or refraction to a wireless device using a second beam based, at least in part, on the first beam identified for the RIS-MT array. In one configuration, the network entity 1902 may include means for obtaining, from a network entity, at least one RIS codebook including at least one RIS configuration for the RIS array. In one configuration, the network entity 1902 may include means for transmitting, for the RIS-MT array, at least one identifier for the at least one RIS codebook, at least one index of the at least one RIS configuration, and a time-hopping schedule for the at least one RIS configuration for the RIS array comprised in the at least one RIS codebook, where transmitting the communication to the RIS array for the reflection or the refraction to the wireless device using the second beam is further based on the at least one identifier for the at least one RIS codebook, the at least one index of the at least one RIS configuration, and the time-hopping schedule. In one configuration, the network entity 1902 may include means for determining the at least one index of the at least one RIS configuration, where transmitting the at least one index of the at least one RIS configuration is based on the determination. In one configuration, the network entity 1902 may include means for receiving, from the network entity or the RIS-MT array, an indication of the at least one index of the at least one RIS configuration, where transmitting the at least one index of the at least one RIS configuration is based on the indication of the at least one index of the at least one RIS configuration. In one configuration, the network entity 1902 may include means for transmitting first reference symbols to the RIS array for reflection to a second network node. In one configuration, the network entity 1902 may include means for receiving a measurement report of the first reference symbols from the second network node, where transmitting the communication to the RIS array for the reflection or the refraction to the wireless device using the second beam is further based on the measurement report of the first reference symbols. In one configuration, the network entity 1902 may include means for receiving first reference symbols over multiple time-frequency resources, where the first reference symbols are reflected or refracted to the first network node by the RIS array from a second network node. In one configuration, the network entity 1902 may include means for measuring the first reference symbols, where transmitting the communication to the RIS array for the reflection or the refraction to the wireless device using the second beam is further based on the measured first reference symbols. In one configuration, the network entity 1902 may include means for configuring the second network node with the multiple time-frequency resources, where receiving the first reference symbols is based on the configuration. In one configuration, the network entity 1902 may include means for transmitting, for the second network node, at least one of: a first indication that the multiple time-frequency resources are to be modified, a second indication that attributes of a beam associated with the first reference symbols are to be modified, a third indication that a transmit power level of the beam is to be modified. In one configuration, the network entity 1902 may include means for transmitting, for the RIS array, first reference symbols over multiple time-frequency resources. In one configuration, the network entity 1902 may include means for measuring a first reflection of the first reference symbols, where transmitting the communication to the RIS array for the reflection or the refraction to the wireless device using the second beam is further based on the measured first reflection of the first reference symbols. In one configuration, the network entity 1902 may include means for transmitting an indication of a periodicity and an offset that the RIS array is to apply during transmission of the first reference symbols over the multiple time-frequency resources, where the reflection of the first reference symbols is based on the indication of the periodicity and the offset, and where measuring the first reflection of the first reference symbols includes measuring the first reflection of the first reference symbols via a subband full-duplex operation. In one configuration, the network entity 1902 may include means for obtaining, from a network entity, (1) at least one RIS codebook including at least one RIS configuration associated with a first reflection or a first refraction between a second network node and a third network node with respect to the RIS array and (2) translation information for changing the first reflection or the first refraction to a second reflection or a second refraction between the second network node and the first network node with respect to the RIS array. In one configuration, the network entity 1902 may include means for transmitting, for the RIS array, the at least one RIS codebook and the translation information, where transmitting the communication to the RIS array for the reflection or the refraction to the wireless device using the second beam is further based on the at least one RIS codebook and the translation information. In one configuration, the network entity 1902 may include means for obtaining, from a network entity, at least one RIS codebook including at least one of: a first indication of an incident signal direction from the first network node to the RIS array, a second indication of a distance between the first network node and the RIS array, at least one RIS configuration, or a set of reflect or refract angles and distance ranges for the wireless device, where transmitting the communication to the RIS array for the reflection or the refraction to the wireless device using the second beam is further based on the first indication, the second indication, the at least one RIS configuration, or the set of reflect or refract angles and the distance ranges. In one configuration, the network entity 1902 may include means for obtaining a range of angle values with respect to a reference coordinate of the first network node or a direction between the first network node and the RIS-MT array, where performing the beam training with the RIS-MT array is based on the range of angle values. In one configuration, the network entity 1902 may include means for selecting a network node from a plurality of network nodes, where transmitting the communication to the RIS array for the reflection or the refraction to the wireless device using the second beam is based on first reference symbols received from the network node or second reference symbols transmitted for the network node. In one configuration, the network entity 1902 may include means for transmitting first reference symbols over first multiple time-frequency resources to the RIS array for reflection or refraction to a second network node. In one configuration, the network entity 1902 may include means for receiving second reference symbols over second multiple time-frequency resources, where the second references symbols are reflected or refracted to the first network node by the RIS array from the second network node, where transmitting the communication to the RIS array for the reflection or the refraction to the wireless device using the second beam is further based on transmitted first reference symbols and the received second reference symbols. In one configuration, the network entity 1902 may include means for combining a set of beams associated with the set of network nodes and the RIS array, where transmitting the communication to the RIS array for the reflection or the refraction to the wireless device using the second beam is further based on combined set of beams. In one configuration, the network entity 2102 may include means for obtaining, from a network entity, (1) an indication of a third beam associated with communication between a second network node and the RIS-MT array and (2) translation information for changing the third beam for communication between the first network node and RIS-MT array or between the first network node and RIS array, where transmitting the communication to the RIS array includes translating the third beam to the second beam based on the translation information. The means may be the RIS component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

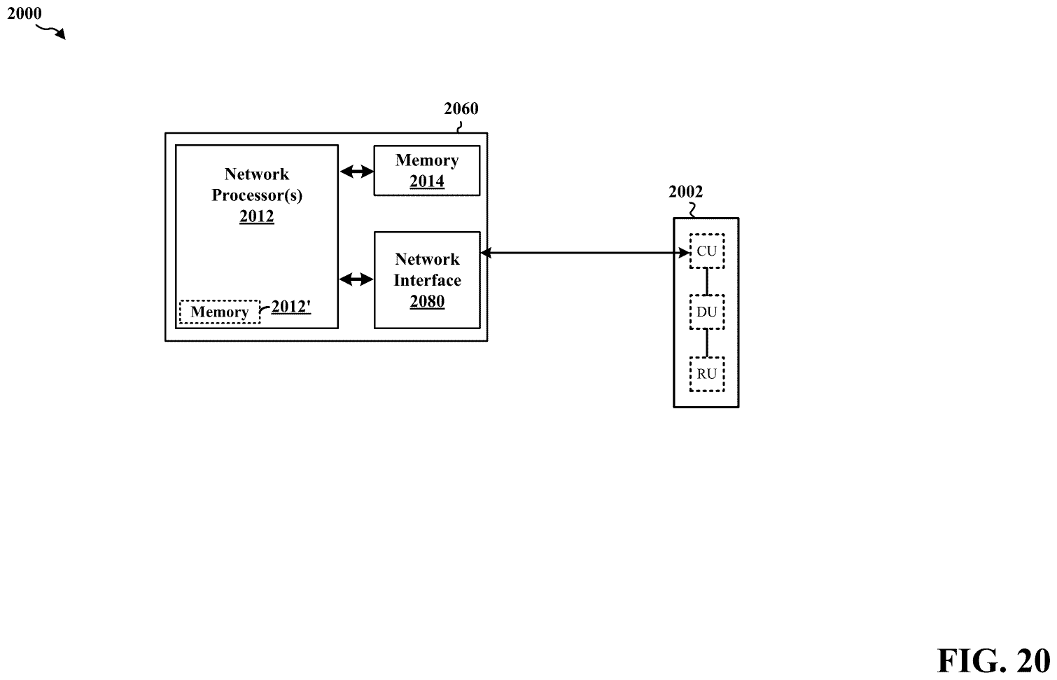

FIG. 20 is a diagram 2000 illustrating an example of a hardware implementation for a network entity 2060. In one example, the network entity 2060 may be within the core network 120. The network entity 2060 may include at least one network processor 2012. The network processor(s) 2012 may include on-chip memory 2012′. In some aspects, the network entity 2060 may further include additional memory modules 2014. The network entity 2060 communicates via the network interface 2080 directly (e.g., backhaul link) or indirectly (e.g., through a RIC) with the CU 2002. The on-chip memory 2012′ and the additional memory modules 2014 may each be considered a computer-readable medium/memory. Each computer-readable medium/memory may be non-transitory. The network processor(s) 2012 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

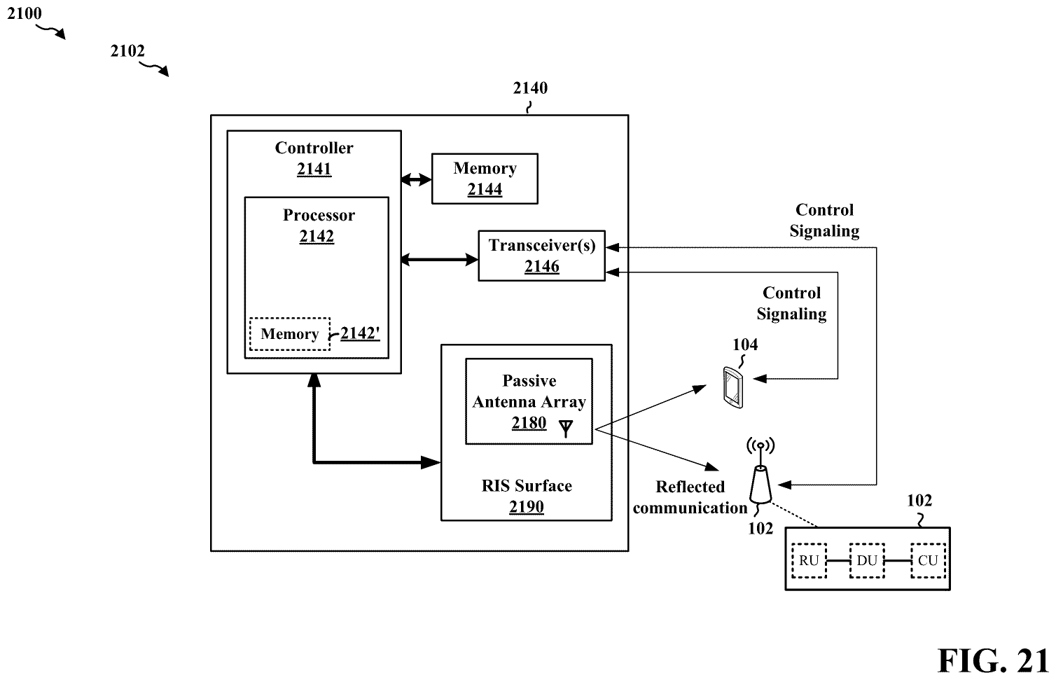

FIG. 21 is a diagram 2100 illustrating an example of a hardware implementation for a RIS 2140. The RIS 2140 includes a RIS surface 2190 that includes a passive antenna array 2180. The RIS surface 2190 includes a surface with a large number of placed reconfigurable elements that can reflect or refract an electromagnetic wave in target directions. In an example, the large number of placed reconfigurable elements may be a large number of densely placed reconfigurable elements or a large number of non-densely placed configurable elements. FIG. 21 illustrates an example of the RIS surface 2190 reflecting communication between a UE 104 and a base station 102. The RIS 2140 includes a controller 2141 that controls an incident angle and an angle of reflection, e.g., by controlling reflection coefficients of the antenna elements of the RIS surface 2190. The controller 2141 may exchange communication, including control signaling or other signaling with a network node such as a base station 102 or a component of a base station 102 and/or a UE 104. The controller 2141 may exchange the communication via at least one transceiver 2146. The controller 2141 may include a processor 2142. The processor 2142 may include on-chip memory 2142′. In some aspects, the controller 2141 may further include additional memory modules 2144. The on-chip memory 2142′ and the additional memory modules 2144 may each be considered a computer-readable medium/memory. Each computer-readable medium/memory may be non-transitory. The processor 2142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As noted above, a RIS may be utilized to increase coverage/spectral efficiency in a wireless communication system. For instance, a LoS may not exist between a base station and a wireless device (e.g., a UE) due to a blockage. The base station may transmit signals via a beam for reflection or refraction to the wireless device via the RIS. The RIS may include a RIS array and a RIS-MT array, where the RIS array and the RIS-MT array may have different capabilities. The base station may engage in a beam training procedure with the RIS-MT array to determine a transmit beam or a receive beam; however, the transmit beam or the receive beam may not be an optimal beam, as the RIS-MT array and the RIS array may have different characteristics (e.g., different sizes, different orientations, different numbers of antenna elements, etc.). Thus, when the base transmits a signal for reflection or refraction to the wireless device via the RIS array, communication reliability may be impacted. Furthermore, the RIS array may operate with a reduced number of antenna elements in certain situations, which may also cause the transmit beam or the receive beam to not be an optimal beam. Additionally, a partial blockage may occur between the base station and the RIS array, which may cause the transmit beam or the receive beam to not be an optimal beam.

Various technologies pertaining to base station to RIS beam refinement are described herein. In an example, a first network node performs beam training with a reconfigurable intelligent surface (RIS) mobile terminal (RIS-MT) array, where the RIS-MT array is associated with a RIS array. The first network node identifies, based on the beam training, a first beam for communication with the RIS-MT array. The first network node transmits communication to the RIS array for reflection or refraction to a wireless device using a second beam based, at least in part, on the first beam identified for the RIS-MT array. Vis-à-vis the above-described technologies, the second beam used for the communication may be a more optimal beam in comparison to the first beam. Thus, the above-described technologies may increase coverage/spectral efficiency in a wireless communication system.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C. B and C, or A and B and C, where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network node, including: performing beam training with a reconfigurable intelligent surface (RIS) mobile terminal (RIS-MT) array, wherein the RIS-MT array is associated with a RIS array; identifying, based on the beam training, a first beam for communication with the RIS-MT array; and transmitting communication to the RIS array for reflection or refraction to a wireless device using a second beam based, at least in part, on the first beam identified for the RIS-MT array.

Aspect 2 is the method of aspect 1, further including: obtaining, from a network entity, at least one RIS codebook including at least one RIS configuration for the RIS array; and transmitting, for the RIS-MT array, at least one identifier for the at least one RIS codebook, at least one index of the at least one RIS configuration, and a time-hopping schedule for the at least one RIS configuration for the RIS array included in the at least one RIS codebook, wherein transmitting the communication to the RIS array for the reflection or the refraction to the wireless device using the second beam is further based on the at least one identifier for the at least one RIS codebook, the at least one index of the at least one RIS configuration, and the time-hopping schedule.

Aspect 3 is the method of aspect 2, wherein the network entity is one of the first network node, a second network node, a core network entity, a centralized unit (CU), or an operations, administration, and maintenance (OAM) entity.

Aspect 4 is the method of any of aspects 2-3, wherein the at least one RIS configuration indicates a plurality of reflection directions or refraction directions or incident directions.

Aspect 5 is the method of any of aspects 2-4, wherein the at least one RIS configuration includes at least one multiple lobe RIS configuration.

Aspect 6 is the method of any of aspects 2-5, further including: determining the at least one index of the at least one RIS configuration, wherein transmitting the at least one index of the at least one RIS configuration is based on the determination.

Aspect 7 is the method of any of aspects 2-5, further including: receiving, from the network entity or the RIS-MT array, an indication of the at least one index of the at least one RIS configuration, wherein transmitting the at least one index of the at least one RIS configuration is based on the indication of the at least one index of the at least one RIS configuration.

Aspect 8 is the method of any of aspects 1-7, further including: obtaining, from a network entity, (1) an indication of a third beam associated with communication between a second network node and the RIS-MT array and (2) translation information for changing the third beam for communication between the first network node and RIS-MT array or between the first network node and RIS array, wherein transmitting the communication to the RIS array includes translating the third beam to the second beam based on the translation information.

Aspect 9 is the method of any of aspects 1-8, wherein the second beam for the communication to the RIS array is based on the first beam identified for the RIS-MT array and translation information for the RIS array relative to the RIS-MT array, and wherein the first beam is associated with a first frequency and the second beam is associated with a second frequency due to the translation information.

Aspect 10 is the method of any of aspects 1-9, further including: transmitting first reference symbols to the RIS array for reflection to a second network node; and receiving a measurement report of the first reference symbols from the second network node, wherein transmitting the communication to the RIS array for the reflection or the refraction to the wireless device using the second beam is further based on the measurement report of the first reference symbols.

Aspect 11 is the method of aspect 10, wherein the first reference symbols are transmitted over multiple time-frequency resources.

Aspect 12 is the method of aspect 11, wherein the first reference symbols are frequency division multiplexed over multiple beams, wherein the measurement report further includes time-frequency identifiers and measured signal strengths for the multiple beams, and wherein transmitting the communication to the RIS array for the reflection or the refraction to the wireless device using the second beam is further based on the time-frequency identifiers and the measured signal strengths.

Aspect 13 is the method of any of aspects 1-9, further including: receiving first reference symbols over multiple time-frequency resources, wherein the first reference symbols are reflected or refracted to the first network node by the RIS array from a second network node; and measuring the first reference symbols, wherein transmitting the communication to the RIS array for the reflection or the refraction to the wireless device using the second beam is further based on the measured first reference symbols.

Aspect 14 is the method of aspect 13, further including: configuring the second network node with the multiple time-frequency resources, wherein receiving the first reference symbols is based on the configuration.

Aspect 15 is the method of any of aspects 13-14, further including: transmitting, for the second network node, at least one of: a first indication that the multiple time-frequency resources are to be modified, a second indication that attributes of a beam associated with the first reference symbols are to be modified, or a third indication that a transmit power level of the beam is to be modified.

Aspect 16 is the method of any of aspects 1-9, further including: transmitting, for the RIS array, first reference symbols over multiple time-frequency resources; and measuring a first reflection of the first reference symbols, wherein transmitting the communication to the RIS array for the reflection or the refraction to the wireless device using the second beam is further based on the measured first reflection of the first reference symbols.

Aspect 17 is the method of aspect 16, wherein measuring the reflection of the first reference symbols includes measuring the reflection of the first reference symbols via a full-duplex operation.

Aspect 18 is the method of any of aspects 16-17, further including: transmitting an indication of a periodicity and an offset that the RIS array is to apply during transmission of the first reference symbols over the multiple time-frequency resources, wherein the reflection of the first reference symbols is based on the indication of the periodicity and the offset, and wherein measuring the first reflection of the first reference symbols includes measuring the first reflection of the first reference symbols via a subband full-duplex operation.

Aspect 19 is the method of any of aspects 1-18, further including: obtaining, from a network entity, (1) at least one RIS codebook including at least one RIS configuration associated with a first reflection or a first refraction between a second network node and a third network node with respect to the RIS array and (2) translation information for changing the first reflection or the first refraction to a second reflection or a second refraction between the second network node and the first network node with respect to the RIS array; and transmitting, for the RIS array, the at least one RIS codebook and the translation information, wherein transmitting the communication to the RIS array for the reflection or the refraction to the wireless device using the second beam is further based on the at least one RIS codebook and the translation information.

Aspect 20 is the method of any of aspects 1-18, further including: obtaining, from a network entity, at least one RIS codebook including at least one of: a first indication of an incident signal direction from the first network node to the RIS array, a second indication of a distance between the first network node and the RIS array, at least one RIS configuration, or a set of reflect or refract angles and distance ranges for the wireless device, wherein transmitting the communication to the RIS array for the reflection or the refraction to the wireless device using the second beam is further based on the first indication, the second indication, the at least one RIS configuration, or the set of reflect or refract angles and the distance ranges.

Aspect 21 is the method of any of aspects 1-20, further including: obtaining a range of angle values with respect to a reference coordinate of the first network node or a direction between the first network node and the RIS-MT array, wherein performing the beam training with the RIS-MT array is based on the range of angle values.

Aspect 22 is the method of any of aspects 1-15 and 19-21, further including: selecting a network node from a plurality of network nodes, wherein transmitting the communication to the RIS array for the reflection or the refraction to the wireless device using the second beam is based on first reference symbols received from the network node or second reference symbols transmitted for the network node.

Aspect 23 is the method of aspect 22, wherein the network node and the RIS array belong to a same distributed unit (DU), wherein the network node and the RIS array belong to different distributed units (DUs) of a same centralized unit (CU), or wherein the network node and the RIS array belong to different centralized units (CUs).

Aspect 24 is the method of aspect 22, wherein the network node is the first network node or a second network node, and wherein selecting the network node includes selecting the network node based on a link budget associated with the RIS array.

Aspect 25 is the method of any of aspects 1-24, further including: transmitting first reference symbols over first multiple time-frequency resources to the RIS array for reflection or refraction to a second network node; and receiving second reference symbols over second multiple time-frequency resources, wherein the second references symbols are reflected or refracted to the first network node by the RIS array from the second network node, wherein transmitting the communication to the RIS array for the reflection or the refraction to the wireless device using the second beam is further based on transmitted first reference symbols and the received second reference symbols.

Aspect 26 is the method of any of aspects 1-24, wherein the RIS array is associated with a set of network nodes, the method further including: combining a set of beams associated with the set of network nodes and the RIS array, wherein transmitting the communication to the RIS array for the reflection or the refraction to the wireless device using the second beam is further based on combined set of beams.

Aspect 27 is an apparatus for wireless communication at a first network node, the apparatus comprising at least one memory and at least one processor coupled to the memory and, based at least in part on information stored in the at least one memory, the at least one processor, individually or in any combination, is configured to perform a method as in any of aspects 1-26.

Aspect 28 is the apparatus of aspect 27, further comprising at least one of a transceiver or an antenna coupled to the at least one processor, wherein the at least one processor is configured to transmit the communication to the RIS array for the reflection or the refraction to the wireless device via at least one of the transceiver or the antenna.

Aspect 29 is an apparatus for wireless communication at a first network node, the apparatus comprising means for performing a method as in any of aspects 1-26.

Aspect 30 is a computer-readable medium (e.g., a non-transitory computer-readable medium storing computer executable code at a first network node, the computer executable code, when executed by at least one processor, causes the at least one processor to perform a method as in any of aspects 1-26.

What is claimed is:

1. An apparatus for wireless communication at a first network node, comprising:
at least one memory; and
at least one processor coupled to the at least one memory and, based at least in part on information stored in the at least one memory, the at least one processor, individually or in any combination, is configured to:
perform beam training with a reconfigurable intelligent surface (RIS) mobile terminal (RIS-MT) array, wherein the RIS-MT array is associated with a RIS array;
identify, based on the beam training, a first beam for communication with the RIS-MT array; and
transmit communication to the RIS array for reflection or refraction to a wireless device using a second beam based, at least in part, on the first beam identified for the RIS-MT array.

2. The apparatus of claim 1, wherein the at least one processor, individually or in any combination, is further configured to:
obtain, from a network entity, at least one RIS codebook comprising at least one RIS configuration for the RIS array; and
transmit, for the RIS-MT array, at least one identifier for the at least one RIS codebook, at least one index of the at least one RIS configuration, and a time-hopping schedule for the at least one RIS configuration for the RIS array comprised in the at least one RIS codebook, wherein to transmit the communication to the RIS array for the reflection or the refraction to the wireless device using the second beam, the at least one processor, individually or in any combination, is configured to transmit the communication to the RIS array for the reflection or the refraction to the wireless device using the second beam further based on the at least one identifier for the at least one RIS codebook, the at least one index of the at least one RIS configuration, and the time-hopping schedule.

3. The apparatus of claim 2, wherein the network entity is one of the first network node, a second network node, a core network entity, a centralized unit (CU), or an operations, administration, and maintenance (OAM) entity.

4. The apparatus of claim 2, wherein the at least one RIS configuration indicates a plurality of reflection directions or refraction directions or incident directions.

5. The apparatus of claim 2, wherein the at least one RIS configuration comprises at least one multiple lobe RIS configuration.

6. The apparatus of claim 2, wherein the at least one processor, individually or in any combination, is further configured to:
determine the at least one index of the at least one RIS configuration, wherein to transmit the at least one index of the at least one RIS configuration, the at least one processor, individually or in any combination, is configured to transmit the at least one index of the at least one RIS configuration based on the determination.

7. The apparatus of claim 2, wherein the at least one processor, individually or in any combination, is further configured to:
receive, from the network entity or the RIS-MT array, an indication of the at least one index of the at least one RIS configuration, wherein to transmit the at least one index of the at least one RIS configuration, the at least one processor, individually or in any combination, is configured to transmit the at least one index of the at least one RIS configuration based on the indication of the at least one index of the at least one RIS configuration.

8. The apparatus of claim 1, wherein the at least one processor is further configured to:
obtain, from a network entity, (1) an indication of a third beam associated with communication between a second network node and the RIS-MT array and (2) translation information for changing the third beam for communication between the first network node and RIS-MT array or between the first network node and RIS array, wherein to transmit the communication to the RIS array, the at least one processor, individually or in any combination, is configured to translate the third beam to the second beam based on the translation information.

9. The apparatus of claim 1, wherein the second beam for the communication to the RIS array is based on the first beam identified for the RIS-MT array and translation information for the RIS array relative to the RIS-MT array, and wherein the first beam is associated with a first frequency and the second beam is associated with a second frequency due to the translation information.

10. The apparatus of claim 1, wherein the at least one processor is further configured to:
transmit first reference symbols to the RIS array for the reflection to a second network node; and
receive a measurement report of the first reference symbols from the second network node, wherein to transmit the communication to the RIS array for the reflection or the refraction to the wireless device using the second beam, the at least one processor, individually or in any combination, is configured to transmit the communication to the RIS array for the reflection or the refraction to the wireless device using the second beam further based on the measurement report of the first reference symbols.

11. The apparatus of claim 10, wherein to transmit the first reference symbols, the at least one processor, individually or in any combination, is configured to transmit the first reference symbols over multiple time-frequency resources.

12. The apparatus of claim 11, wherein the first reference symbols are frequency division multiplexed over multiple beams, wherein the measurement report further comprises time-frequency identifiers and measured signal strengths for the multiple beams, and wherein to transmit the communication to the RIS array for the reflection or the refraction to the wireless device using the second beam, the at least one processor, individually or in any combination, is configured to transmit the communication to the RIS array for the reflection or the refraction to the wireless device using the second beam based on the time-frequency identifiers and the measured signal strengths.

13. The apparatus of claim 1, wherein the at least one processor, individually or in any combination, is further configured to:
receive first reference symbols over multiple time-frequency resources, wherein the first reference symbols are reflected or refracted to the first network node by the RIS array from a second network node; and
measure the first reference symbols, wherein to transmit the communication to the RIS array for the reflection or the refraction to the wireless device using the second beam, the at least one processor, individually or in any combination, is configured to transmit the communication to the RIS array for the reflection or the refraction to the wireless device using the second beam further based on the measured first reference symbols.

14. The apparatus of claim 13, wherein the at least one processor, individually or in any combination, is further configured to:
provide the second network node with a configuration for the multiple time-frequency resources, wherein to receive the first reference symbols, the at least one processor, individually or in any combination, is configured to receive the first reference symbols based on the configuration.

15. The apparatus of claim 13, wherein the at least one processor, individually or in any combination, is further configured to:
transmit, for the second network node, at least one of:
a first indication that the multiple time-frequency resources are to be modified,
a second indication that attributes of a beam associated with the first reference symbols are to be modified, or
a third indication that a transmit power level of the beam is to be modified.

16. The apparatus of claim 1, wherein the at least one processor, individually or in any combination, is further configured to:
transmit, for the RIS array, first reference symbols over multiple time-frequency resources; and
measure a first reflection of the first reference symbols, wherein to transmit the communication to the RIS array for the reflection or the refraction to the wireless device using the second beam, the at least one processor, individually or in any combination, is configured to transmit the communication to the RIS array for the reflection or the refraction to the wireless device using the second beam further based on the measured first reflection of the first reference symbols.

17. The apparatus of claim 16, wherein to measure the reflection of the first reference symbols, the at least one processor, individually or in any combination, is configured to measure the reflection of the first reference symbols via a full-duplex operation.

18. The apparatus of claim 16, wherein the at least one processor, individually or in any combination, is further configured to:
transmit an indication of a periodicity and an offset that the RIS array is to apply during transmission of the first reference symbols over the multiple time-frequency resources, wherein the reflection of the first reference symbols is based on the indication of the periodicity and the offset, and wherein to measure the first reflection of the first reference symbols, the at least one processor, individually or in any combination, is configured to measure the first reflection of the first reference symbols via a subband full-duplex operation.

19. The apparatus of claim 1, wherein the at least one processor, individually or in any combination, is further configured to:
obtain, from a network entity, (1) at least one RIS codebook comprising at least one RIS configuration associated with a first reflection or a first refraction between a second network node and a third network node with respect to the RIS array and (2) translation information for changing the first reflection or the first refraction to a second reflection or a second refraction between the second network node and the first network node with respect to the RIS array; and
transmit, for the RIS array, the at least one RIS codebook and the translation information, wherein to transmit the communication to the RIS array for the reflection or the refraction to the wireless device using the second beam, the at least one processor, individually or in any combination, is configured to transmit the communication to the RIS array for the reflection or the refraction to the wireless device using the second beam further based on the at least one RIS codebook and the translation information.

20. The apparatus of claim 1, wherein the at least one processor, individually or in any combination, is further configured to:
obtain, from a network entity, at least one RIS codebook comprising at least one of: a first indication of an incident signal direction from the first network node to the RIS array, a second indication of a distance between the first network node and the RIS array, at least one RIS configuration, or a set of reflect or refract angles and distance ranges for the wireless device, wherein to transmit the communication to the RIS array for the reflection or the refraction to the wireless device using the second beam, the at least one processor, individually or in any combination, is configured to transmit the communication to the RIS array for the reflection or the refraction to the wireless device using the second beam further based on the first indication, the second indication, the at least one RIS configuration, or the set of reflect or refract angles and the distance ranges.

21. The apparatus of claim 1, wherein the at least one processor, individually or in any combination, is further configured to:
obtain a range of angle values with respect to a reference coordinate of the first network node or a direction between the first network node and the RIS-MT array,
wherein to perform the beam training with the RIS-MT array, the at least one processor, individually or in any combination, is configured to perform the beam training with the RIS-MT array based on the range of angle values.

22. The apparatus of claim 1, wherein the at least one processor, individually or in any combination, is further configured to:
select a network node from a plurality of network nodes, wherein to transmit the communication to the RIS array for the reflection or the refraction to the wireless device using the second beam, the at least one processor, individually or in any combination, is configured to transmit the communication to the RIS array for the reflection or the refraction to the wireless device using the second beam based on first reference symbols received from the network node or second reference symbols transmitted for the network node.

23. The apparatus of claim 22, wherein the network node and the RIS array belong to a same distributed unit (DU), wherein the network node and the RIS array belong to different distributed units (DUs) of a same centralized unit (CU), or wherein the network node and the RIS array belong to different centralized units (CUs).

24. The apparatus of claim 22, wherein the network node is the first network node or a second network node, and wherein to select the network node, the at least one processor, individually or in any combination, is configured to select the network node based on a link budget associated with the RIS array.

25. The apparatus of claim 1, wherein the at least one processor, individually or in any combination, is further configured to:
transmit first reference symbols over first multiple time-frequency resources to the RIS array for the reflection or the refraction to a second network node; and
receive second reference symbols over second multiple time-frequency resources, wherein the second references symbols are reflected or refracted to the first network node by the RIS array from the second network node, wherein to transmit the communication to the RIS array for the reflection or the refraction to the wireless device using the second beam, the at least one processor, individually or in any combination, is configured to transmit the communication to the RIS array for the reflection or the refraction to the wireless device using the second beam further based on transmitted first reference symbols and the received second reference symbols.

26. The apparatus of claim 1, wherein the RIS array is associated with a set of network nodes, wherein the at least one processor, individually or in any combination, is further configured to:
combine a set of beams associated with the set of network nodes and the RIS array, wherein to transmit the communication to the RIS array for the reflection or the refraction to the wireless device using the second beam, the at least one processor, individually or in any combination, is configured to transmit the communication to the RIS array for the reflection or the refraction to the wireless device using the second beam further based on combined set of beams.

27. The apparatus of claim 1, further comprising at least one of a transceiver or an antenna coupled to the at least one processor, wherein to transmit the communication to the RIS array for the reflection or the refraction to the wireless device, the at least one processor, individually or in any combination, is configured to transmit the communication to the RIS array for the reflection or the refraction to the wireless device via at least one of the transceiver or the antenna.

28. A method of wireless communication at a first network node, comprising:
performing beam training with a reconfigurable intelligent surface (RIS) mobile terminal (RIS-MT) array, wherein the RIS-MT array is associated with a RIS array;
identifying, based on the beam training, a first beam for communication with the RIS-MT array; and
transmitting communication to the RIS array for reflection or refraction to a wireless device using a second beam based, at least in part, on the first beam identified for the RIS-MT array.

29. An apparatus for wireless communication at a first network node, comprising:
means for performing beam training with a reconfigurable intelligent surface (RIS) mobile terminal (RIS-MT) array, wherein the RIS-MT array is associated with a RIS array;
means for identifying, based on the beam training, a first beam for communication with the RIS-MT array; and
means for transmitting communication to the RIS array for reflection or refraction to a wireless device using a second beam based, at least in part, on the first beam identified for the RIS-MT array.

30. A computer-readable medium storing computer executable code at a first network node, the computer executable code, when executed by at least one processor, causes the at least one processor to:
perform beam training with a reconfigurable intelligent surface (RIS) mobile terminal (RIS-MT) array, wherein the RIS-MT array is associated with a RIS array;
identify, based on the beam training, a first beam for communication with the RIS-MT array; and
transmit communication to the RIS array for reflection or refraction to a wireless device using a second beam based, at least in part, on the first beam identified for the RIS-MT array.
